(19) United States
(12) Patent Application Publication
(10) Pub. No.: US 2018/0158068 A1
(43) Pub. Date: Jun. 7, 2018

(54) METHODS AND SYSTEMS RELATING TO ELECTRONIC COMMERCE

(71) Applicant: ZiNATION, INC., Ottawa (CA)

(72) Inventor: David Ker, Ottawa (CA)

(21) Appl. No.: 15/830,228

(22) Filed: Dec. 4, 2017

Related U.S. Application Data
(60) Provisional application No. 62/429,349, filed on Dec. 2, 2016.

(51) Int. Cl. G06Q 30/00; G06Q 50/00

(52) U.S. Cl. CPC G06Q 30/016; H04L 67/02; G06Q 50/01

(57) ABSTRACT

Chatbots represent an automated conversation engine which an enterprise can associate with a website in order to parse standard customer queries and provide predetermined responses. However, apart from limited data relating to how often it is accessed, how often certain queries are given etc. then their benefit to the customer and enterprise longer term is low. However, users and enterprises would benefit from an e-commerce conversation interface to support not only decision making, but also procurement, delivery and after sales support as well as allowing the user to perform all, or a subset, of the steps within e-commerce. Embodiments of the invention provide this and beneficially provide for the e-commerce conversation system to be provided as either a social network, a social network plug-in, and an application plug-in for software applications including, but not limited to, web based interactive magazines known as Zines™ established by the inventor.

### CROSS-REFERENCE TO RELATED APPLICATIONS

This application claims the benefit of priority from U.S. Provisional Patent Application 62/429,349 filed Dec. 2, 2016 entitled “Methods and Systems relating to Electronic Commerce” the entire contents of which are incorporated herein by reference.

### FIELD OF THE INVENTION

This invention relates to electronic commerce and more particularly to enhanced communications during electronic commerce and supporting communications through enhanced online publishing solutions supporting multiple channels and dynamic content.

### BACKGROUND OF THE INVENTION

Electronic commerce, commonly referred to as e-commerce or eCommerce, is the trading or facilitation of trading in products or services using computer networks, such as the Internet. Electronic commerce draws on a wide variety of technologies such as mobile commerce, electronic funds transfer, supply chain management, Internet marketing, online transaction processing, electronic data interchange (EDI), inventory management systems, and automated data collection systems. Modern electronic commerce typically uses the World Wide Web for at least one part of the transaction's life cycle although it may also use other technologies such as e-mail.

However, in comparison to traditional sales activities within bricks-and-mortar operations, where a customer may engage sales staff to obtain information, leave, return to continue with the same member of staff or others, online electronic commerce is generally performed in isolation by the customer without any interaction with the enterprise they are purchasing the product and/or service from. Whilst some websites support limited text based interaction through a “chat” apart from conventional telephone helplines and are discrete to support in product details. As such the user has no communication history from one web “chat” to another nor ability to engage others within the “chat” such as friends etc. Likewise, the enterprise employee, where it is a real person rather than an artificial intelligence driven interface, cannot bring other members of their organization into the conversation to engage with the consumer nor link a supplier, original equipment manufacturer etc.

It would be beneficial to provide consumers, enterprise buyers and others engaged within business-to-consumer, business-to-business, and business-to-government activities with a communications based interface supporting ongoing conversation with respect to a product and/or a service throughout the entire procurement cycle so that a user can view a conversation at all stages which may include all, or a subset, of purchasing decision making, procurement, delivery, and post-delivery sales support.

It would be further beneficial for the e-commerce conversation interface to support not only decision making, but also procurement, delivery and after sales support as well as allowing the user to perform all, or a subset, of the steps within e-commerce. Further, it would be beneficial for the e-commerce conversation system to be provided as either a social network, a social network plug-in, and an application plug-in for software applications including, but not limited to, web based interactive magazines known as Zines™ established by the inventor through ZiNation™.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to electronic commerce and more particularly to enhanced communications during electronic commerce and supporting communications through enhanced online publishing solutions supporting multiple channels and dynamic content.

In accordance with an embodiment of the invention there is provided a method of tracking conversations relating to an item of merchandise between multiple parties via an automated agent interacting with the multiple parties as at least one party of the multiple parties.

In accordance with an embodiment of the invention the method also provides that each party of the multiple parties except the automated agent is selected from a group associated with the item of merchandise, the group comprising a consumer, a retailer, a distributer and an original equipment manufacturer.

In accordance with an embodiment of the invention the method also provides for the automated agent to act as two or more parties of the multiple parties, one being customer centric downstream from the retailer and the other enterprise centric upstream from the retailer.

In accordance with an embodiment of the invention the method also provides that tracking the conversations comprises acquiring them independent of the electronic medium of communication and associating them with the item of merchandise.

In accordance with an embodiment of the invention there is provided a method of tracking conversations relating to a service between multiple parties via an automated agent interacting with the multiple parties as at least one party of the multiple parties.

In accordance with an embodiment of the invention the method also provides each party of the multiple parties except the automated agent is selected from a group associated with the service, the group comprising a consumer, a retailer, a distributer and an original equipment manufacturer.

In accordance with an embodiment of the invention the method also provides the automated agent to act as two or more parties of the multiple parties, one being customer centric downstream from the retailer and the other enterprise centric upstream from the retailer.

In accordance with an embodiment of the invention the method also provides that tracking the conversations comprises acquiring them independent of the electronic medium of communication and associating them with the service.

In accordance with an embodiment of the invention there is provided a method of providing a user with a sequential thread of conversations relating to either an item of merchandise or a service wherein the thread of conversations involves the user and at least one of individuals associated with the user via a social network, an enterprise associated with the at least one of the item of merchandise and the service, and an automated agent.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a wireless portable electronic device supporting communications to a network such as depicted in FIG. 1 and as supporting embodiments of the invention;

FIG. 3A depicts a typical web based electronic commerce process flow according to the prior art;

FIGS. 3B and 3C depict a “Zine” publishing and content management system configuration according to an embodiment of the invention;

FIGS. 4A and 4B depict the application of a publishing and content management system according to an embodiment of the invention generating published content on-demand within a website for a retailer;

FIGS. 5A and 5B depict the application of a publishing and content management system according to an embodiment of the invention generating published content on-demand to an online shopping process for a user across multiple web sites;

FIG. 6 depicts schematically a typical sales-delivery process as supported by embodiments of the invention;

FIG. 7 depicts prior art user interfaces for order management presented to a consumer and a business according to the prior art;

FIG. 8A depicts conceptually the overlap between product information, personalized storefront, and product information management systems exploiting the inventor concept of Zines™;

FIG. 8B depicts the systems of FIG. 8A overlaid with a first level of embodiments of the invention relating to commerce management and automation and artificial intelligence;

FIG. 8C depicts the systems of FIG. 8B overlap with a second level of embodiments of the invention with an e-commerce management system integrated to all other systems and a partner portal for enterprises exploiting the e-commerce management system;

FIG. 9A depicts a sales-delivery process as supported by embodiments of the invention;

FIG. 9B depicts the sales-delivery process according to FIG. 9 as supported by embodiments of the invention with the e-commerce management system integrated according to embodiments of the invention interacting with all other systems with the partner portal for enterprises exploiting the e-commerce management system with business side (ZANI™) and consumer side (ZINA™) interfaces;

FIG. 10 depicts first and second webpages exploiting a Zine™ and an e-commerce communication management system according to an embodiment of the invention during an initial communication session start-up;

FIG. 11 depicts first and second webpages exploiting a Zine™ and an e-commerce communication management system according to an embodiment of the invention during a subsequent stage of the communication;

FIGS. 12 and 13 depict first to fourth webpages exploiting a Zine™ and an e-commerce communication management system according to an embodiment of the invention during subsequent stages of the communication;

FIG. 14 depicts an e-commerce communication management system according to an embodiment of the invention within a third-party commerce management system from a consumer's viewpoint;

FIG. 15 depicts an e-commerce communication management system according to an embodiment of the invention within a third-party commerce management system from an enterprise's viewpoint;

FIG. 16 depicts an e-commerce communication management system according to an embodiment of the invention within an application wherein the user is presented with their purchasing history and purchasing contacts;

FIGS. 17A to 17C depict an e-commerce communication management system according to an embodiment of the invention within an application embedded as an add-on to a social network wherein the e-commerce communication management system presents communications via the familiar user interface of the social network for the user; and

FIG. 18 depicts an e-commerce communication management system according to an embodiment of the invention operating as a social network.

### DETAILED DESCRIPTION

The present invention is directed to electronic commerce and more particularly to enhanced communications during electronic commerce and supporting communications through enhanced online publishing solutions supporting multiple channels and dynamic content.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader. A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application” and an element of a “software suite” as used herein may refer to, but is not limited to, a computer program designed to allow an individual to perform an activity. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED for the purposes of presenting a micro-survey to a consumer and/or customer.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™)

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third-party provider of a service and/or a product to an enterprise. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arms length” provider of a service and/or a product to an enterprise and/or service provider wherein the consumer and/or customer engages the third party but the actual service and/or product that they are interested in and/or purchase.

A “user” as used herein may refer to, but is not limited to, an enterprise, a service provider, and an individual accessing at least one of publishing software and/or publishing software according to embodiments of the invention from the viewpoint of publishing information.

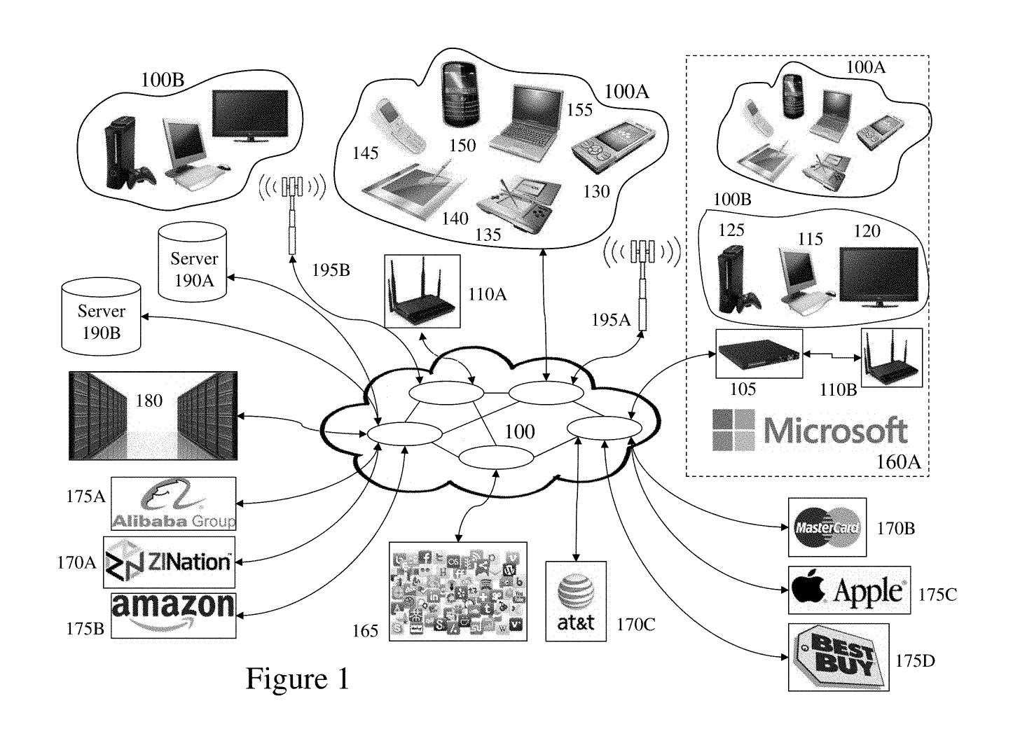

Referring to FIG. 1 there is depicted a network environment 100 within which embodiments of the invention may be employed supporting publishing systems and publishing applications/platforms (ECEAPs) according to embodiments of the invention. Such ECEAPs, for example supporting multiple channels and dynamic content. As shown first and second user groups 100A and 100B respectively interface to a telecommunications network 100. Within the representative telecommunication architecture, a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second cellular APs 195A and 195B respectively which provide Wi-Fi cells for first and second user groups 100A and 100B respectively. Also connected to the network 100 are first and second Wi-Fi nodes 110A and 110B, the latter of which being coupled to network 100 via router 105. Second Wi-Fi node 110B is associated with Enterprise 160, e.g. Microsoft™, within which are other first and second user groups 100A and 100B. Second user group 100B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including, for example, a gaming console 125, a personal computer 115 and wireless/Internet enabled television 120 as well as a cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-2000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 and Bluetooth as well in an ad-hoc manner.

Also connected to the network 100 are Social Networks (SOCNETS) 165, first to third service providers 170A to 170C respectively, e.g. ZiNation™, MasterCard™, and AT&T™ together with first to fourth third party providers 175A to 175D respectively, e.g. Alibaba™, Amazon™, Apple™, and Best Buy™ as well as first and second servers 190A and 190B which together with others, not shown for clarity. First and second servers 190A and 190B may host according to embodiments of the inventions multiple services associated with a provider of electronic commerce and electronic applications/platforms (ECEAPs); a provider of a SOCNET or Social Media (SOME) exploiting ECEAP features; a provider of a SOCNET and/or SOME not exploiting ECEAP features; a provider of services to PEDS and/or FEDS; a provider of one or more aspects of wired and/or wireless communications; an Enterprise 160 exploiting ECEAP features; license databases; content databases; image databases; content libraries; customer databases; websites; and software applications for download to or access by FEDs and/or PEDs exploiting and/or hosting ECEAP features. First and second primary content servers 190A and 190B may also host for example other Internet services such as a search engine, financial services, third party applications and other Internet based services.

Accordingly, a consumer and/or customer (CONCUS) may exploit a PED and/or FED within an Enterprise 160, for example, and access one of the first or second primary content servers 190A and 190B respectively to perform an operation such as accessing/downloading an application which provides ECEAP features according to embodiments of the invention; execute an application already installed providing ECEAP features; execute a web based application providing ECEAP features; or access content. Similarly, a CONCUS may undertake such actions or others exploiting embodiments of the invention exploiting a PED or FED within first and second user groups 100A and 100B respectively via one of first and second cellular APs 195A and 195B respectively and first Wi-Fi nodes 110A.

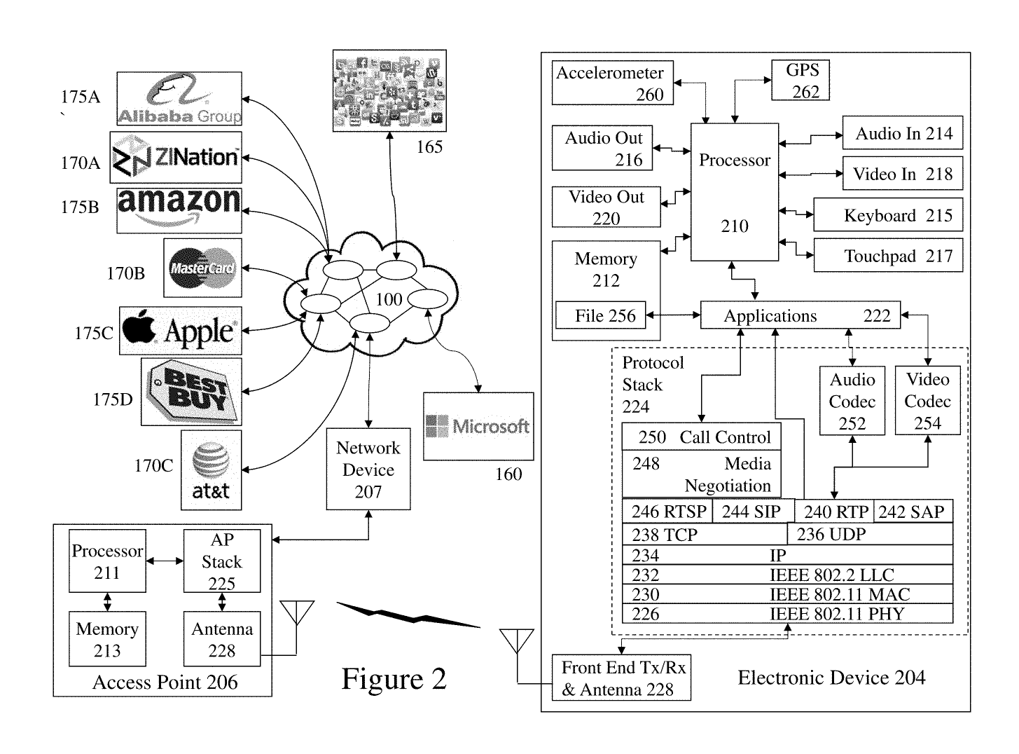

Now referring to FIG. 2 there is depicted an electronic device 204 and network access point 207 supporting ECEAP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to network 100 and therein Social Networks (SOCNETS) 165, first to third service providers 170A to 170C respectively, e.g. ZiNation™, MasterCard™, and AT&T™ together with first to fourth third party providers 175A to 175D respectively, e.g. Alibaba™, Amazon™, Apple™, and Best Buy™ as well as first and second servers 190A and 190B which together with others, not shown for clarity.

The electronic device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 204 may include an audio input element 214, for example a microphone, and an audio output element 216, for example, a speaker, coupled to any of processors 210. Electronic device 204 may include a video input element 218, for example, a video camera or camera, and a video output element 220, for example an LCD display, coupled to any of processors 210. Electronic device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the electronic device 204. The one or more applications 222 that are typically stored in memory 212 and are executable by any combination of processors 210. Electronic device 204 also includes accelerometer 260 providing three-dimensional motion input to the process 210 and GPS 262 which provides geographical location information to processor 210.

Electronic device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the electronic device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-2000, DSL, Dial-Up, DOCSIS, Ethernet, G.hn, ISDN, MoCA, PON, and Power line communication (PLC).

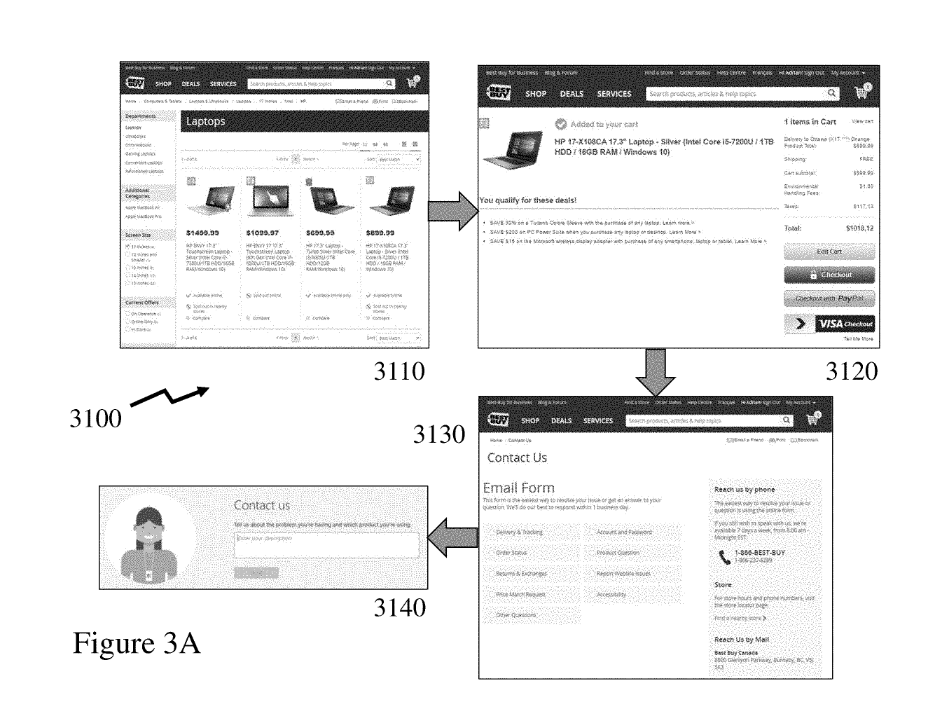

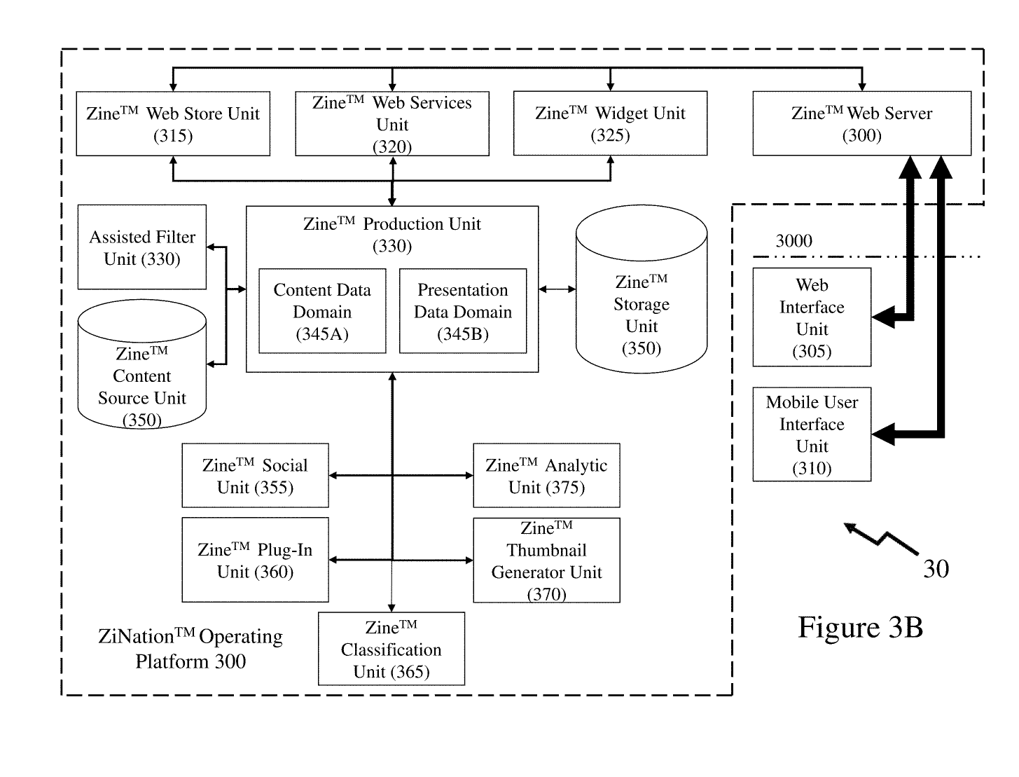

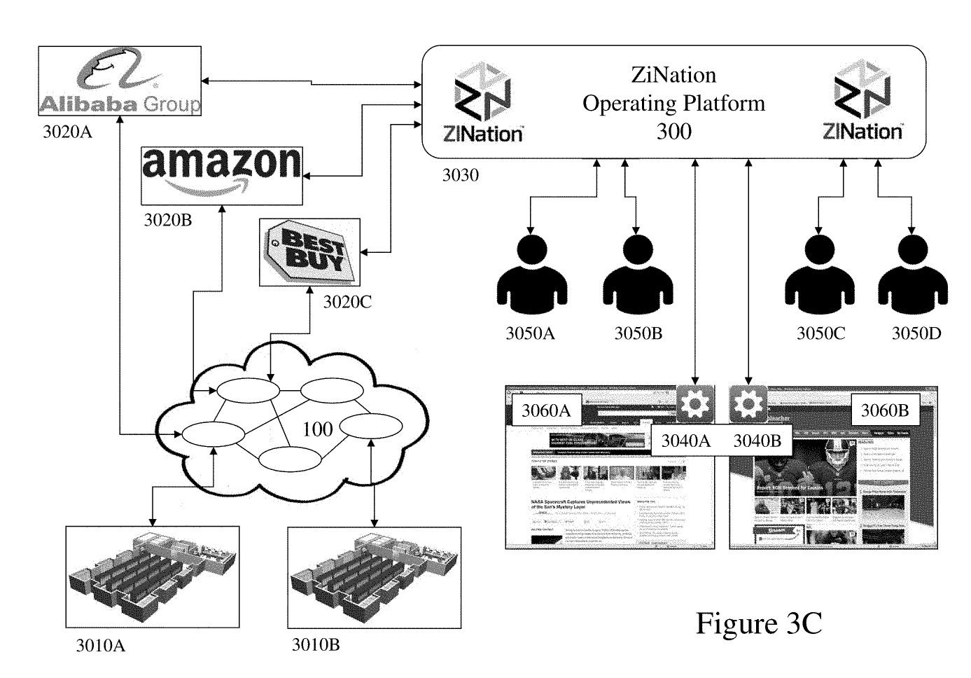

Within the prior art a user seeking to undertake to perform an electronic commerce activity with a third party, such as represented by first to fourth third party providers 175A to 175D respectively, e.g. Alibaba™, Amazon™, Apple™, and Best Buy™, would access their respective website and make a purchase or access help through typical webpages such as those depicted in FIG. 3A. Accordingly, a user has accessed a third party provider, in this instance fourth third party provider Best Buy™ and performed a search within the online product offerings. In this instance, in first image 3110 the user has achieved this by selecting a plurality of filters, in this instance “Laptop” for product category, “17” for screen dimension, “Intel” for microprocessor installed, and “HP” for manufacturer. From the products displayed they have selected a “HP 17.3”' Laptop—Intel Core i5-7200U″ with 1 TB hard disk drive (HDD), 16 GB RAM and Windows 10 installed and then accessed their online “cart” or “shopping cart” as depicted in second image 3120. If they require assistance then they can link to the help section of the website, depicted in third image 3130, giving them the option to email, call, or visit a physical retail store (which is not always as option either through geographical restrictions, mobility restrictions, or the retailer being online only).

In some instances, the third-party provider may provide online support to an “agent” via a pop-up window or other method as known in the art, such as depicted with fourth image 3140. If the user has not registered for an account and logged in, then unless a request for some identification information of the user is requested, the help/support/advise etc. provided is essentially to an anonymous user. However, even if the user has an account, when they log off the website, close the web browser window etc. the conversation with the agent of the third-party provider is lost. Further, every conversation with the third-party provider is discrete if they come back again even if for the same product/service etc.

However, a user may also access web content through alternate means such as that described and presented by the inventor within WO/2015/154,164 published Oct. 15, 2015 entitled “Methods and Systems Relating to Electronic Multi-Domain Publishing” which establishes a publication and electronic content management platform concept which the inventor refers to as a “Zine” wherein the platform has the ability to support multiple channels and provide “one-to-one” publishing and user specific or user defined content management. Zine has been a term associated most commonly within the prior art with a small circulation self-published work of original or appropriated texts and images reproduced via photocopier since this is a popular low-cost format for distribution. Accordingly, a Zine™ within the remainder of this application relates to a software system and/or software application (SSSA) providing all or part of the features of a publishing SSSA according to embodiments of the invention. Zine™ being a trademark of ZiNation™ an operating business of Lassoo the Web Inc. An exemplary Zine™ publishing and electronic content management system/platform is depicted in FIG. 3B with a Zine™ web server 300 within system 30.

As depicted a web interface unit 305 and mobile user interface unit 310 provide external interfaces between a Zine™ web server 300 allowing users to access published content and publish content according to embodiments of the invention. Web interface 305 and mobile user interface 310 are depicted as hosted external to a delineation boundary 3000 whilst a ZiNation™ Operating Platform 300 is the other side of the delineation boundary 3000. Interfaced to the Zine™ web server 300 are Zine™ web store unit 315 wherein published content may be accessed by users according to the access privileges they have upon the Zine™ SSSA. Such privileges may, for example, be public in that they can access any published content stored within the Zine™ web store unit 315 that has been tagged as publicly accessible or it may be all public published content plus published content associated with the publisher, company, organization, etc. to which their access privileges are associated. Naturally content published with the Zine™ SSSA may be provided to users through traditional techniques including, but not limited to, attachments to electronic mail, attachments to Simple Message Service (SMS) text messages, hypertext markup accessible links in websites or other content, and PDFs downloadable from a website via a browser.

Zine™ web services unit 320 provides external services such as, for example, provisioning of a web portal through which users can access the Zine™ SSSA to publish content, view published content, etc. Zine™ widget unit 325 provides the required interfaces for third party application to exploit the Zine™ SSSA within their own applications, e.g. a word processor application, an Internet browser, realtor website, etc. Each of these communicates with the Zine™ production unit 340 which maintains two databases, content data domain 345A and presentation data domain 345B. The content data domain 345A maintains associated with each item of published content a list of the content elements it comprises whilst presentation data domain 345B maintains a series of filters, each filter associated with a category of published content and, optionally, a display format. Zine™ production unit 340 is itself interfaced to a Zine™ storage unit 350 which provides storage of the content elements employed in published content, storage of the filters, and storage of fixed format published content (i.e. published content that will not be dynamically adjusted to suit the device from which a user is accessing it.)

Assisted filter unit 330 and Zine content source unit 335 are also interfaced to the Zine™ production unit 340 and provide Zine™ SSSA assisted filtering during publishing from user selected/determined content and database of content sources as in many instances a user may be seeking to publish dynamic content or time varying content and accordingly in addition to storage of the content elements within the Zine™ storage unit 350 it may be appropriate to store the pointer to the information, e.g. RSS feed from British Broadcasting Corporation (http://feeds.bbci.co.uk/news/rss.xml).

Also interfaced to the Zine production unit 340 are:
Zine™ social unit 355 which interfaces to SOCNETs/SOMEs to provide Zine™ functionality such as via Zine™ widget unit 325;
Zine™ plug-in unit 360 which interfaces to external website to provide Zine™ functionality such as via Zine™ widget unit 325;
Zine™ classification unit 365 which allows classification processes to be executed on published Zine™ content;
Zine™ thumbnail generator 370 which generates thumbnail images of published content for provisioning to mobile device users, for example, prior to the provisioning of published content published to them for their particular mobile device; and
Zine™ analytic unit 375 which allows a variety of analytical processes to be executed either upon Zine™ content, Zine™ users, or Zine™ accesses for example.

Now referring to FIG. 3C there is depicted an operating environment for a ZiNation™ Operating Platform 300 such as discussed in respect of FIG. 3B supra. As depicted the ZiNation™ Operating Platform 300 is connected to first and second widgets 3040A and 3040B respectively which are associated with first and second websites 3060A and 3060B respectively and provide access to the ZiNation™ Operating Platform 300 through the first and second websites 3060A and 3060B respectively to publish content that they access and/or generated through either or both of the first and second websites 3060A and 3060B as well as other websites, not shown for clarity. Also shown connected to the ZiNation™ Operating Platform 300 are first to fourth users 3050A to 3050D respectively representing users who may access the ZiNation™ Operating Platform 300 via a PED or FED respectively either to access published content or to publish content.

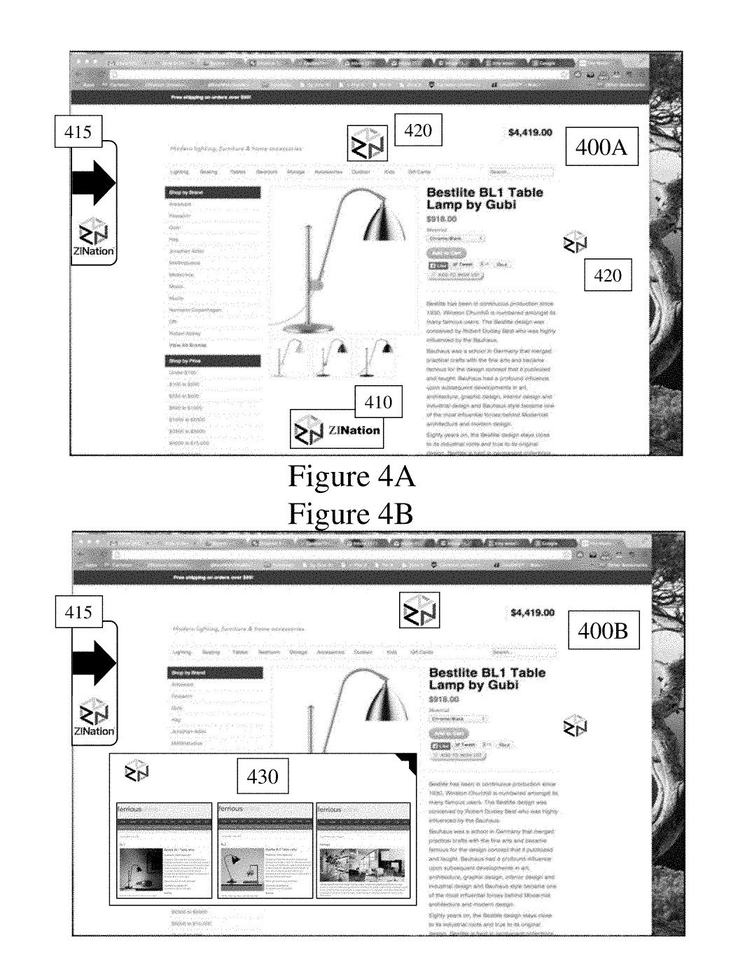

Also depicted are first to third application/service providers 3020A to 3020C respectively disposed between the ZiNation™ Operating Platform 300 and network 100. These represent application/service providers embedding the ZiNation™ Operating Platform 300 into their website operations such as FastPencil™ (a self-publishing company), Treasure Chest Social Classifieds™ (an online social network enabled classified advertising company), and Wikipedia™ (a free encyclopedia). Also connected to the network 100 are first and second datacenters 3010A and 3010B respectively which may, for example, host the ZiNation™ Operating Platform 300 as well as first to third application/service providers 3020A to 3020C respectively and first and second websites 3060A and 3060B respectively together with other applications, services, data, and content. Accordingly, a user such as first to fourth users 3050A to 3050D respectively may access multiple websites such as those associated with first to third application/service providers 3020A to 3020C respectively and establish selections of goods and/or services of interest to them and may generate a Zine™ such as described and depicted by the inventors within WO/2015/154,164 published Oct. 15, 2015 entitled “Methods and Systems Relating to Electronic Multi-Domain Publishing.” Alternatively, they may select items from their personally created Zines™, other user Zines™, and Zines™ created by application/service providers such as first to third application/service providers 3020A to 3020C respectively. Accordingly, as will become evident in the following description in respect of FIGS. 4 to 16 respectively these Zines™ may form the basis of engaging within electronic commerce exploiting electronic commerce and electronic applications/platforms (ECEAPs) according to embodiments of the invention.

Referring to FIG. 4A then a user is similarly accessing a web screen 400A with first and second ZiNation™ ECEAP links 420 respectively in addition to the icon 410 and first web toolbar 415 allowing the user to access a range of features of an ECEAP according to an embodiment of the invention and/or a software system and/or software application (SSSA) supporting Zine™ functionality. Selection of first ZiNation™ SSSA link 410 yields second web screen 400B wherein pop-up 430 is presented to the user. Pop-up 430 is a Zine™ relating to the manufacturer of the Bestlite BL1 table lamp. Alternatively, selection of the second ZiNation™ SSSA link 420 may trigger a pop-up which presents a Zine™ associated with the enterprise, e.g. The Modern Shop, such as their lighting catalog.

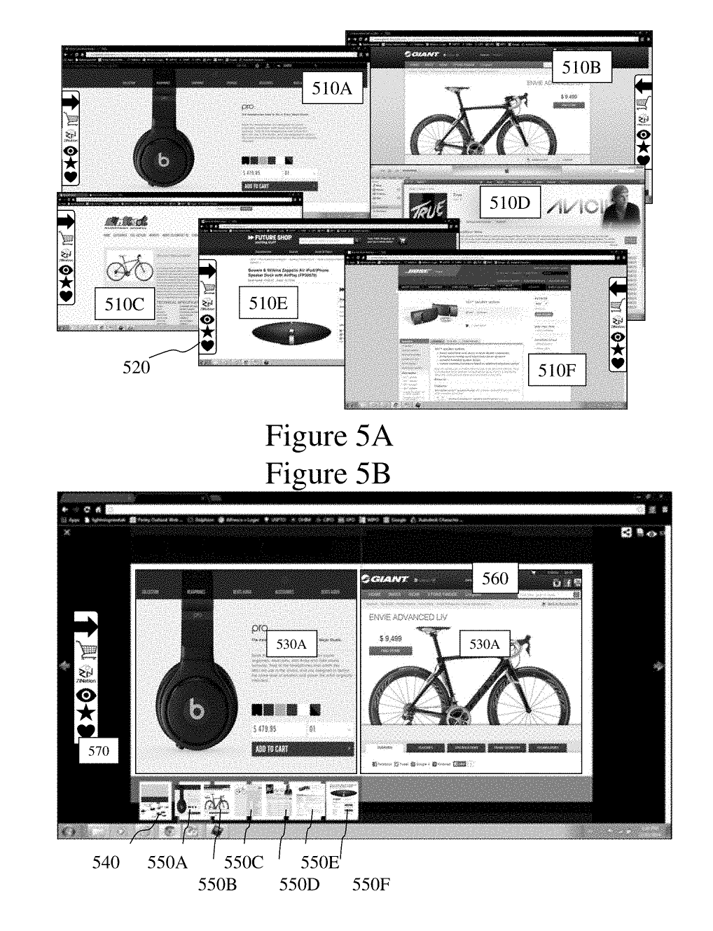

Now referring to FIG. 5A there are depicted first to sixth webpages 510A to 510F respectively representing webpages which a user has accessed and made selections within exploiting features of a ZiNation™ SSSA such as an icon 820 or toolbar 815 as described supra. Accordingly, the use via toolbar 520 within each of the first to sixth webpages 510A to 510F respectively identify content, e.g. via the ZiNation icon within the toolbar 520. Subsequently, the user may access a Zine™ 560, as depicted in FIG. 5B, comprising, for example, comprising a cover page 1940 and first to sixth pages 1950A to 1950F respectively representing content the user selected from their activities within first to sixth webpages 510A to 510F. Accordingly, as depicted the user is viewing first and second pages 530A and 530B respectively, being Beats™ Audio and Giant™ bicycles, derived from first and second webpage 510A and 510B. Also depicted in FIG. 5B is toolbar 570 which contains a purchasing icon, depicted as a shopping trolley, allowing the user to select an item for purchase from the single or multiple Zine™ generated by the user.

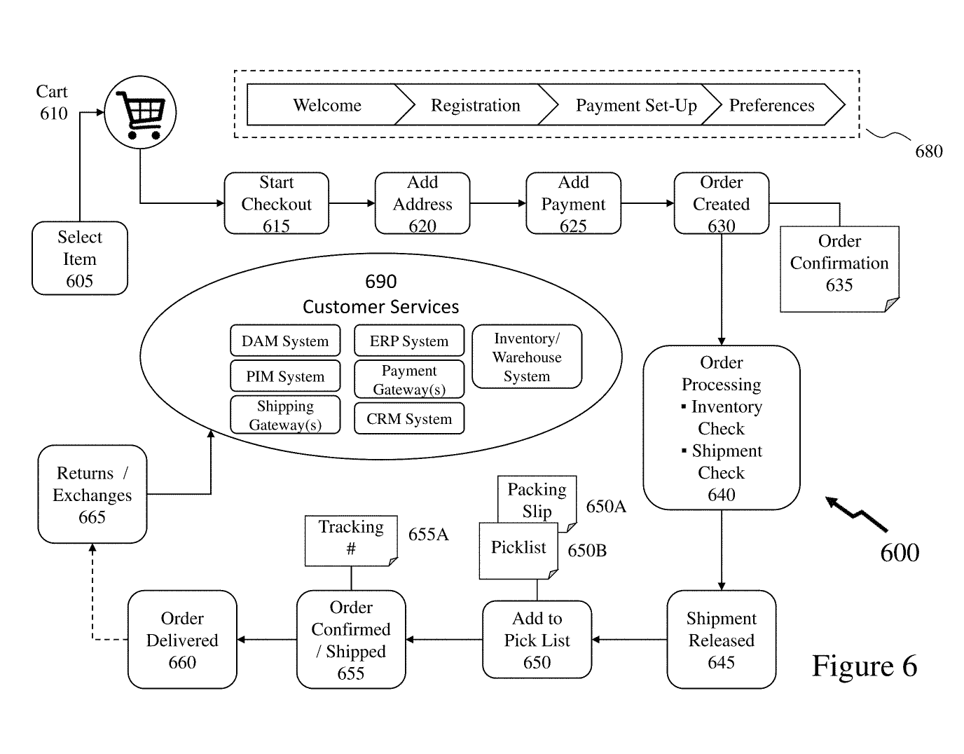

Now referring to FIG. 6 there is depicted an exemplary sales cycle 600 according to the prior art within which embodiments of the invention may be exploited. As depicted a user establishes through an initial account creation process 680 an account with an ECEAP wherein they can subsequently access one or more websites, one or more Zines™, etc. Subsequently, the user creates a “shopping cart” (Cart) 610 by making selection of a service and/or item in step 605. Accordingly, after selecting the item(s) they wish to obtain (purchase) they proceed to steps 615 to 630 respectively comprising:
Step 615 wherein the user initiates a checkout process;
Step 620 wherein the user confirms the address for delivery (as this may be different from the address of the user when they established the account);
Step 625 wherein the user adds their payment method during their checkout process; and
Step 630 wherein the order is created triggering the generation of an order confirmation 635 and the completed order is progressed to step 640.

Step 640 is performed at a distributor, warehouse, or other retail location associated with the service and/or goods and/or vendor the user purchased through wherein the order is processed through steps (not shown for clarity) of inventory checks, inventory retrieval, packaging, and pre-shipment checking. Accordingly, the exemplary sales cycle 600 proceeds to steps 645 to 660 wherein:
Step 645 wherein the shipment is released for delivery;
Step 650 wherein the shipment is added to a picklist to which are combined picklist 650B and packing slip 650A allowing for partial shipments, multiple delivery addresses, out-of-stock handling etc. to be performed in conjunction with the order;
Step 655 wherein the order is confirmed and shipped wherein a tracking number (#) 655A may be associated when delivery is via a courier service (for example); and
Step 660 wherein the order is delivered to the user or the person/enterprise etc. identified for that item(s) within the order created in step 630.

An optional step 665 is depicted in the event of an issue with the delivery with step 665 and returns/exchanges wherein the user engages with the Customer Services 690 to schedule a return/exchange, notify of a defect etc. This may involve further steps as the customer returns the product back, typically via a second courier process. Customer Services 690 comprises multiple systems including, but not limited to:
Digital Asset Management (DAM) System: DAM relates management tasks and decisions surrounding the ingestion, annotation, cataloguing, storage, retrieval and distribution of digital assets;
Enterprise Resource Planning (ERP) System: ERP is business-management software, typically a suite of integrated applications, that an organization can use to collect, store, manage and interpret data from many business activities, including product planning, purchase; manufacturing or service delivery; marketing and sales; inventory management; shipping and payment; and finance;
Product Information System (PIM) System: facilitates the recording, tracking, and management of certain types of “personal information”;
Payment Gateway(s): provide a merchant services through an e-commerce application service provider that authorizes payments processing for e-businesses, online retailers, bricks and clicks, or traditional brick and mortar;
Shipping Gateway(s): provide a merchant services through an e-commerce application service provider that provides links to shipping service(s) allowing shipping to be quoted in the ordering process and scheduled during the order confirmation process;
Customer Relationship Management (CRM) System: CRM systems manage a company's interaction with current and potential future customers and compile information from different communication channels, including a company's website, telephone, email, live chat, marketing materials, social media, etc. with a view to analyzing a target market and defining how best to engage that market; and
Inventory/Warehouse Management (IWM) System: IWM may be discrete inventory management system (IMS) and warehouse management system (WMS) or a combined linked system where IMS provides tracking inventory levels, orders, sales and deliveries whilst WMS is intended to support warehouse or distribution center management.

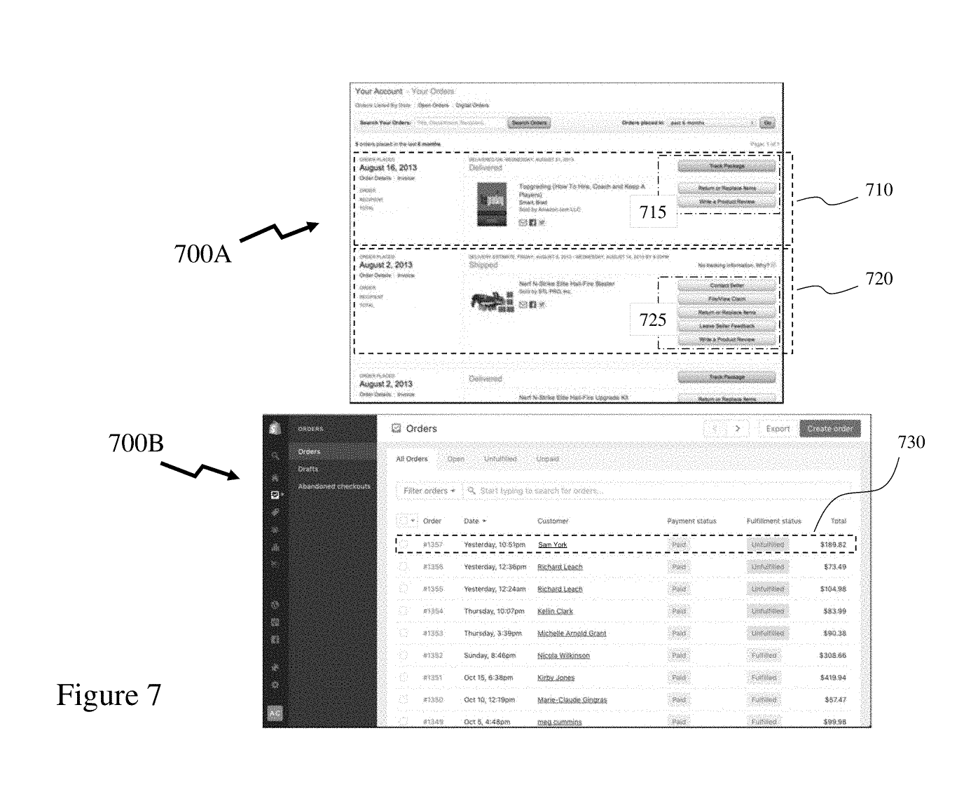

Now referring to FIG. 7 there are depicted first and second order tracking windows 700A and 700B respectively as provided to a consumer and enterprise respectively. Within first window 700A, in this instance associated with Amazon™. This depicts first and second orders 710 and 720 respectively with information for the consumer such as the item purchased, the date purchased, cost, order status (e.g. delivered, shipped), as well as links to other functions through first and second button groups 715 and 725 respectively. First button group 715 comprising buttons allowing the user to track package, return or replace items, and write a product review. In contrast second button group 725 provides the user with options to contact seller, file—view claim, return or replace items, leave seller feedback, and write a product review. The additional options of contacting the seller and filing/viewing claims being provided due to the nature of the product orders, in this instance a Nerf™ “N-Strike Elite Hail Fire Blaster” which as a projectile based entertainment device carries risks and the seller has elected to offer additional support to the user.

In contrast second tracking window 700B represents an order tracking window such as presented to an enterprise rather than a consumer such as in first tracking window 700A which is a web browser based webpage graphical user interface (GUI) accessing remotely stored information. Second tracking window 70B is generated in contrast by a locally executing application that allows the enterprise to access and manage their orders to a supplier whether connected to the network or not and is data centric rather than image centric as with first tracking window 700A. Accordingly, the user is presented with a tabulated listing of the orders raised by the enterprise with information such as order # (being that employed within the enterprise rather than the supplier allowing cost tracking, asset management etc. to be performed, the date of purchase, who ordered within the enterprise, the payment status, the order fulfilment status and the total value of the order. Exemplary order 730 therefore indicates that “Sam York” placed order #1357 for goods valued at $189.82 and that whilst the order was paid for the goods have not been delivered. The user may select a hyperlink within the such as that associated with order “#1357” in order to obtain more details or item specifics etc. Second tracking window 700B provides additional filtering features to the user as well as the ability to create a new order and export data from the tabulated order history, such as into a spreadsheet, email, or comma-separated-value (CSV) format.

However, such prior art systems and interfaces treat the order process as a series of discrete stages with no or minimal interaction between. Typically, the process prior to an order creating and establishing a cart to checkout from is completely disconnected from any subsequent processes which are generally linked by at least an order number. As such a typical process would comprise:
pre-sales: where the customer determines products of interest, researches, and establishes a purchasing decision;
sales: where the customer makes an order purchasing one or more items;
post-sales: wherein the supplier/retailer ships the ordered item(s) to the user; and
customer services: wherein issues associated with the order are addressed although this step can actually be in parallel to the post-sales.

At each stage the user may have interaction with one or more individuals and these activities are not associated and accessible during the entire sales cycle. Where a user rings a customer for help or information during pre-sales then such information is not stored except potentially in a digital recording of the conversation held for a predetermined period of time in case of issues of harassment etc. or employing the call in a training session. When the customer orders there is no linkage to their pre-sales engagement and information stored is either nil or minimal information such as with utilities that may track when the customer last rang and log any actions triggered. Similarly, post-order and customer services are generally discrete and disconnected from preceding actions etc. For the user this is frustrating as information obtained during a call may be forgotten and is not accessible expect by repeating their contact to the enterprise or that information provided during an earlier stage is now regarded as “hearsay” in a subsequent stage when the purchased object that the user was told had features A, B, and C during a pre-sales engagement turns out to have features A, D, and E and they want to return the item.

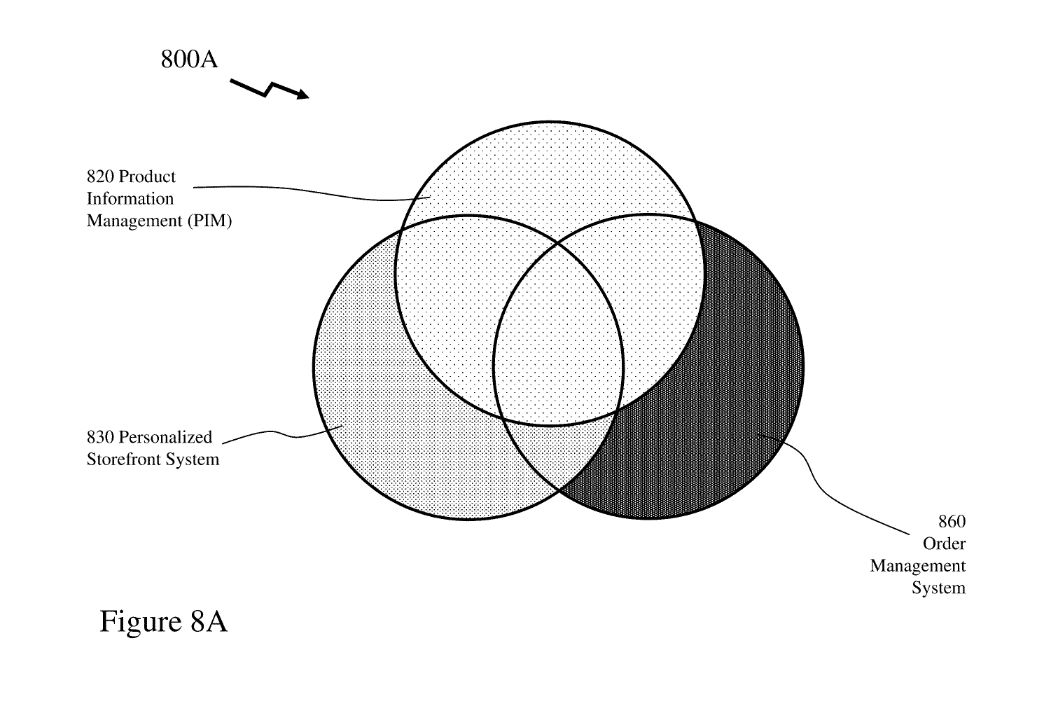

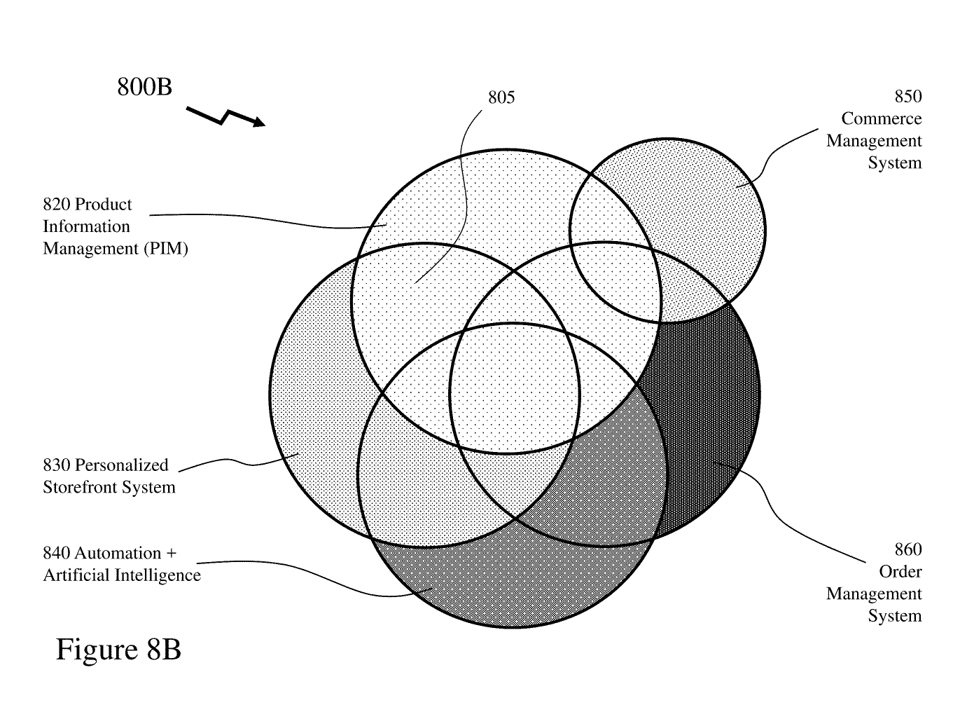

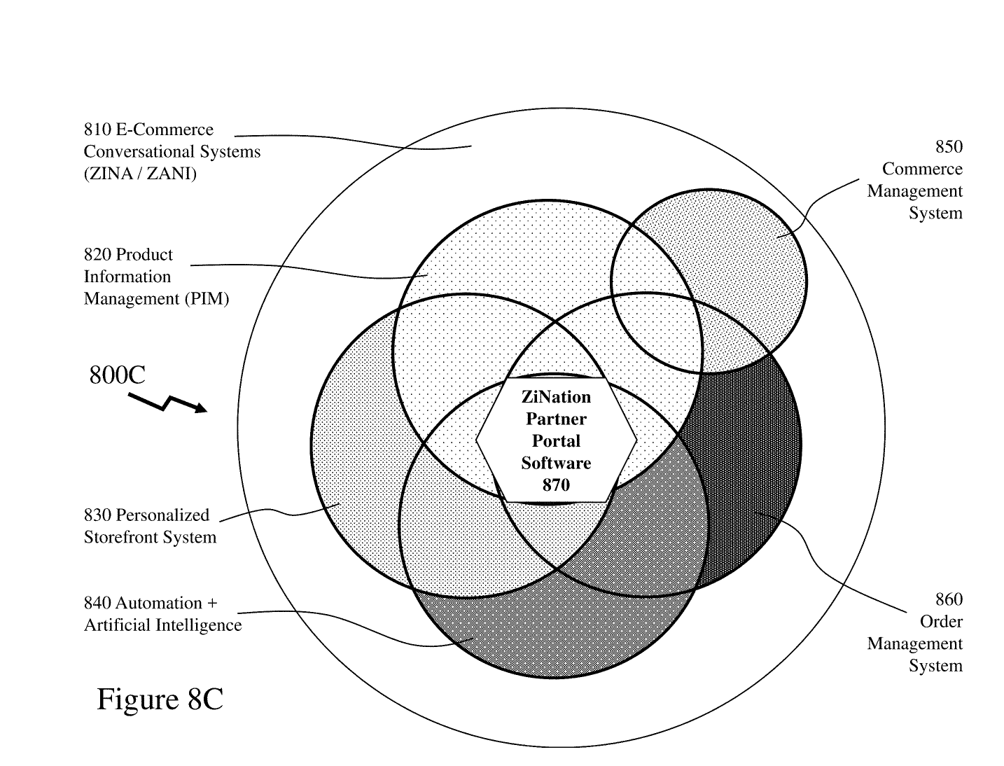

In contrast the inventors consider that all stages of the sales cycle and the purchasing process are linked, and that information should be accumulated within a record associated with an item, user, and/or order rather than discarded etc. Accordingly, referring to FIG. 8A there is a first view of a sales process according to the visualization of the inventors wherein users and enterprises exploit in different weighting and manners a number of software applications and/or interfaces wherein by exploiting a range of personalization concepts established by the inventors as described below and with respect to their prior patent application WO/2015/154,164 published Oct. 15, 2015 entitled “Methods and Systems Relating to Electronic Multi-Domain Publishing” which establishes a publication and electronic content management platform through the concept of Zines™ which allow, for example, for an enterprise to establish interactive catalog (a published Zine™), a user to create a “shopping list”/“wish list” (a user specific Zine™ which may be shared), and for a visual receipt to be generated (a Zine™ with image and data relating to the purchases). Each Zine™ supporting hyperlinking and HTML language for dynamic features such as linking to product website, retailer website, etc. from a receipt or wish list for example.

Accordingly, the overall concepts of Zines™ described and depicted within WO/2015/154,164 published Oct. 15, 2015 entitled “Methods and Systems Relating to Electronic Multi-Domain Publishing” may form part of a personalized storefront (PS) system 830 wherein the user may access retailers to perform product and/or service research etc. The product information accessible to the user is managed through a Product Information Management (PIM) system 820 whilst activities relating to purchasing/order management etc. are managed through an Order Management (OM) system 860. As depicted in FIG. 8A the PS system 830, PIM system 820, and OM system 860 are interlinked and overlap rather than being discrete elements as considered within the prior art. This interlinking and overlap being facilitated as depicted in FIG. 8B by a layer of Automation and Artificial Intelligence (AAI) system 840 which interacts/intercepts the PS system 830, PIM system 820, and OM system 860. Also depicted is Commerce Management (CM) System 850 which overlaps both PIM system 820 and OM system 860.

However, whilst this first embodiment of a sales process system provides for increased integration/overlap and hence communication between the different stages/elements there are still aspects of the user/enterprise engagement throughout the whole process that are not accessible to all stages of the order process. For example, consider in FIG. 8B the PIM system 820 and PS system 830 then these have an overlapping region 805 which does not overlap OM system 860. Similar regions exist between other steps of the order process such as between PIM system 820 and OM system 860 that are not overlapping with PS system 830. Accordingly, communications within these “overlap” regions are not accessible. The inventors have employed circular zones for different elements of the overall system such as the PIM system 820, PS system 830, AAI system 840 and OM system 860 whereas it would be evident to one skilled in the art that according to the scope/breadth of the functionality within different steps that other shapes and/or sizes of zones may be employed without departing from the scope of the invention to reflect the different systems and their overlaps and/or interactions.

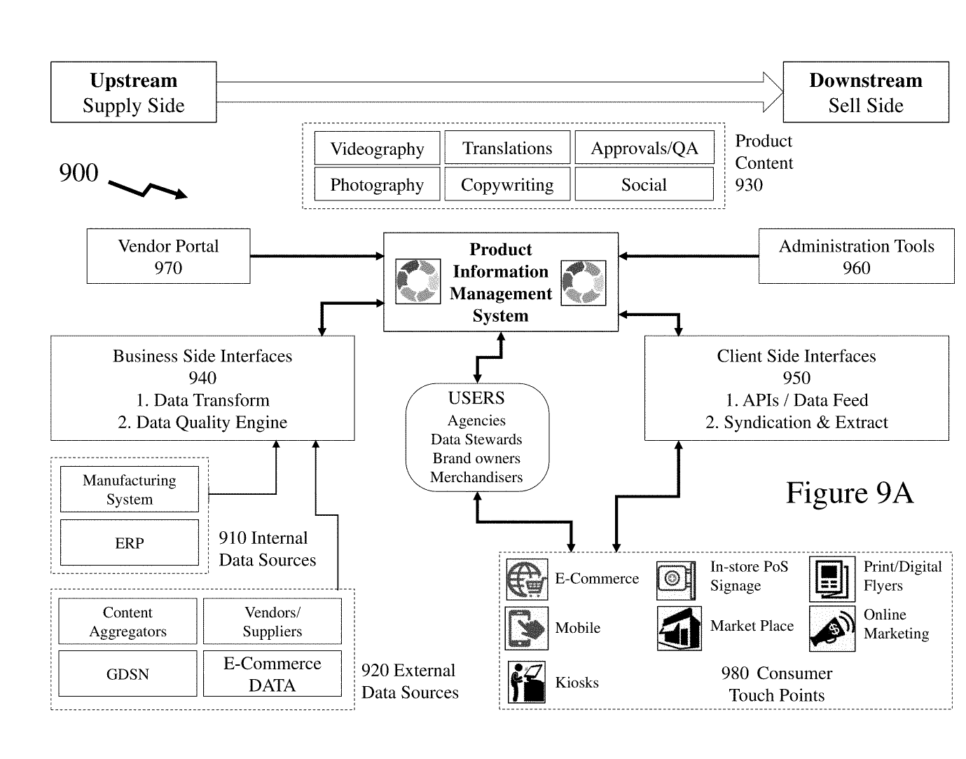

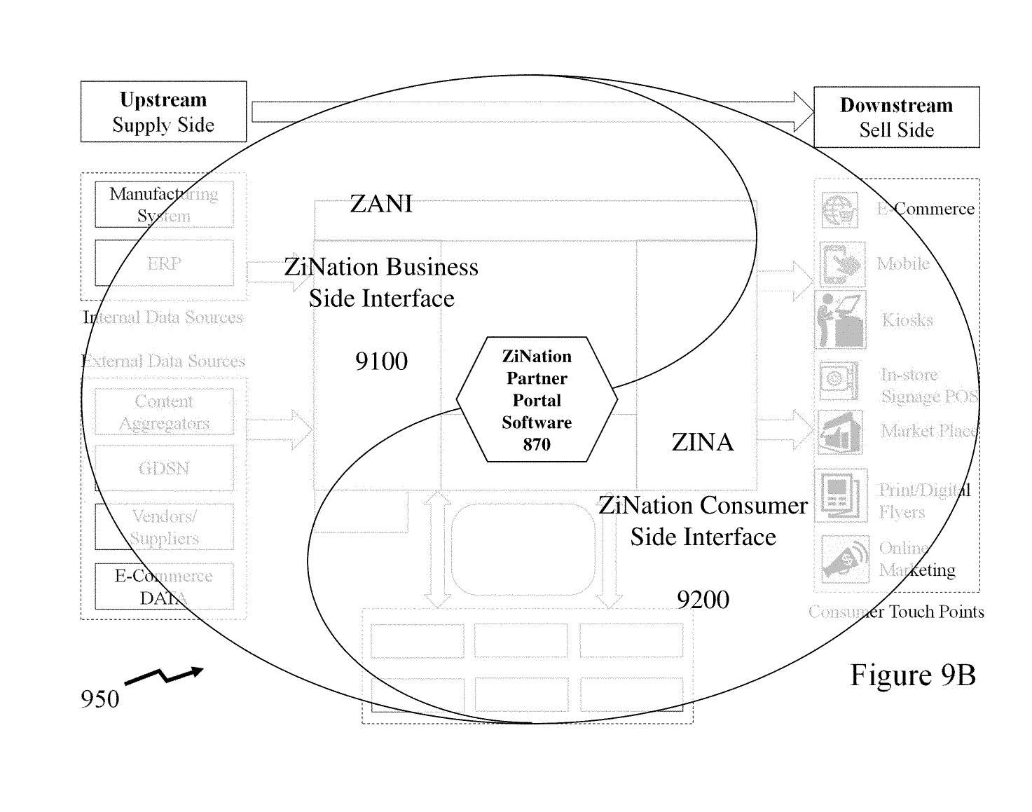

Accordingly, referring to FIG. 8C the configuration depicted in FIG. 8B is now represented with expansions according to embodiments of the invention. Centrally there is disposed ZiNation Partner Portal Software (ZI-PPS) 870 which overlays the PIM system 820, PS system 830, AAI 840, and OM system 860 which provides for connectivity between all these systems and links them to the E-Commerce Conversational (E-CoCo) Systems 810 referred to within this document as ZINA and ZANI. ZINA being a consumer facing or consumer centric E-CoCo system 810 whilst ZANI provides an enterprise facing or enterprise centric E-CoCo system 810. These both being described and depicted below in respect of FIGS. 9 to 16.

Referring to FIG. 9A there is depicted an e-commerce environment 900 within which E-CoCo systems 810 according to embodiments of the invention such as ZINA and ZANI may operate such as depicted in FIG. 9B. Accordingly, within e-commerce environment 900 the process is depicted from a supply side (upstream) to sell side (downstream) for a consumer orientated process wherein an enterprise upstream seeks to sell to its customers downstream. It would be evident to one of skill in the art that other e-commerce environments 900 may be defined for business-to-business (B2B), business-to-government (B2G), and customer-to-customer (C2C) in addition to the business-to-consumer (B2C) depicted in FIG. 9A. Accordingly, the enterprise accesses internal data sources 910, e.g. manufacturing system and ERP, and external data sources 920, e.g. e-commerce data, vendors/suppliers, content aggregators, and Global Data Synchronization Network (GDSN). The internal and external data sources 910 and 920 couple to business side interfaces 940 within a PIM system which has downstream client-side interfaces 950 which are coupled to customer touch points 980. Customer touch points 980 including, but not limited to, e-commerce and mobile (via Internet or direct email/social network), kiosks, in-store point-of-sale (PoS), market places, print/digital flyers, and online marketing. The PIM system further includes administration tools 960 and vendor portal 970. The PIM system also accesses product content 930.

Now referring to FIG. 9B the e-commerce environment 900 is depicted as e-commerce environment 950 wherein the ZiNation Partner Portal Software 870 according to an embodiment of the invention overlays the PIM system whilst ZiNation Business Side Interface 9100, ZANI, and ZiNation Consumer Side Interface 9200, ZINA overlay the PIM system to their respective upstream and downstream enterprise (business) and customer sides respectively.

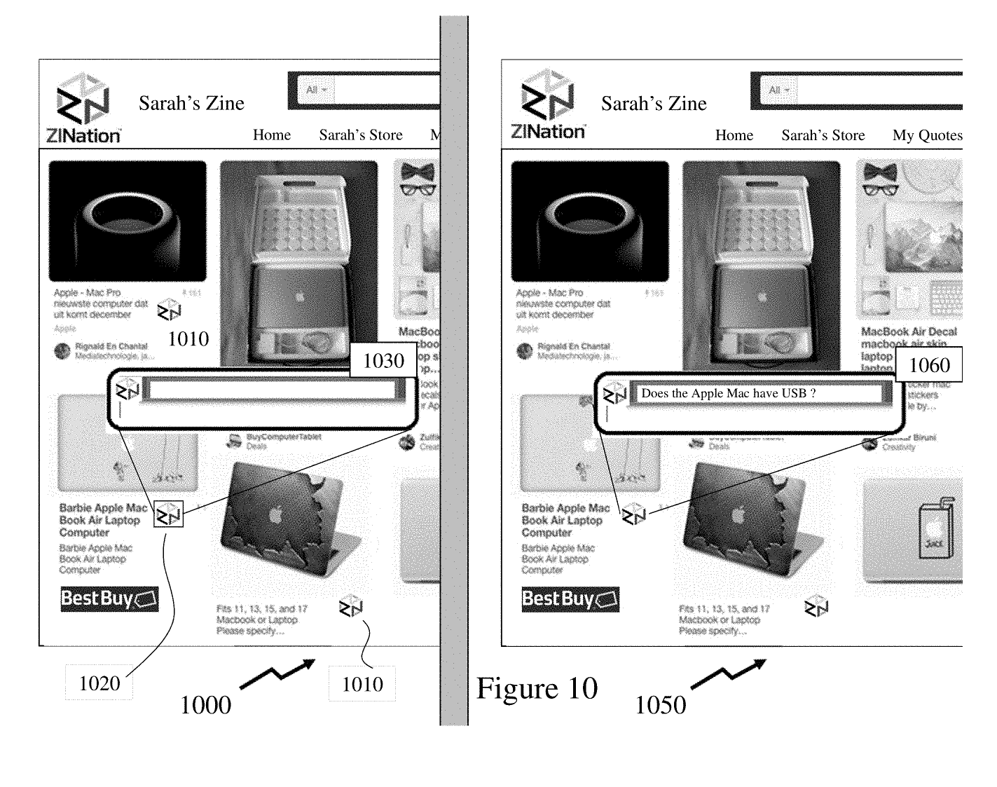

Referring to FIG. 10 there are depicted first and second images 1000 and 1050 respectively with respect to a consumer' s ZINE (Co-ZINE) accessed through a web portal such as ZiNation directly or through an application plug-in for a social network etc. exploiting an E-CoCo system according to an embodiment of the invention. Depicted within the customer' s ZINE are products selected by the user and/or recommended for the user via their friends within one or more social networks. Adjacent each item within the Co-ZINE also includes a ZINA icon 1010 allowing the user to access ZINA, the ZiNation consumer side interface such as ZINA ZiNation consumer side interface 9200 in FIG. 9B or E-Commerce Conversational System 810 in FIG. 8C. Accordingly, in first image the user has selected ZINA icon 1020, depicted with an outline to denote selection for ease of reference in the Figure, triggering ZINA pop-up 1030. Selected ZINA icon 1020 being associated with “Barbie Apple Mac Book Air Laptop.” As this is the first selection of the ZINA icon 1020 then the conversation is empty wherein the user as depicted in second image 1050 may enter a query, in this instance “Does the Apple Mac have USB?”

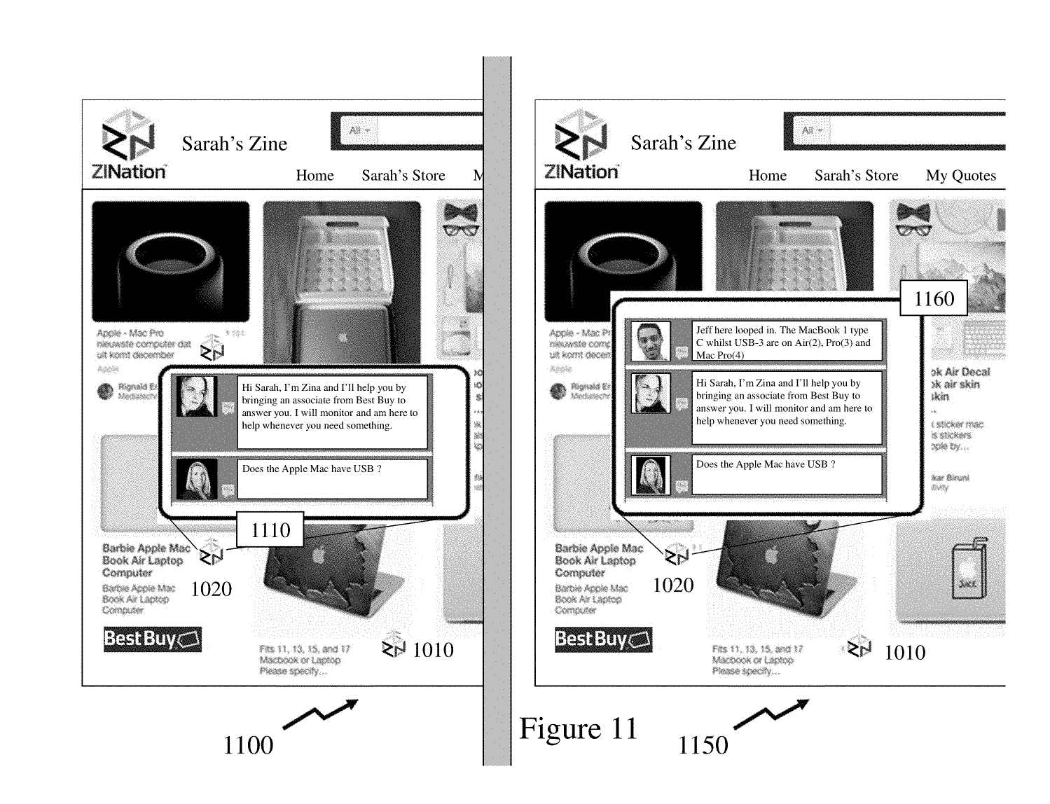

Now referring to FIG. 11 there are depicted first and second images 1100 and 1150 respectively with respect to a consumer' s ZINE (Co-ZINE) accessed through a web portal such as ZiNation directly or through an application plug-in for a social network etc. exploiting an E-CoCo system according to an embodiment of the invention. Within first image 1100 a first pop-up 1110 triggered through the user's selection of the ZINA icon 1010 associated with the “Barbie Apple Mac Book Air Laptop”, the selected ZINA icon 1020 now reflects that “Zina” has responded to “Sarah” whose ZINE is being accessed. Subsequently, in second image 1150 this first pop-up 1110 changes to second pop-up 1160 to reflect that the conversation is now joined by “Jeff”, a sales associate at BestBuy™. In this instance BestBuy™ being selected as the “Barbie Apple Mac Book Air Laptop” was added to “Sarah's ZINE” through selection of the item by the user when accessing the BestBuy™ online website.

However, it would be evident that in other instances personal preferences established by the user explicitly or through their activities with ZINA would direct them to a suitable supplier. For example, the user may prefer a particular retailer such as Sears™ for example, a vendor within eBay™, or buying through Amazon™. In each instance either ZINA defaults to the preference or provides the user with option, e.g. responds with a message such as “Do you want to contact BestBuy™ or would you prefer to use Amazon™ as usual?”

Whilst the conversation depicted within the pop-ups 1060, 1110, and 1160 is depicted as text the actual format of the entry from the user, ZINA or the BestBuy™ sales agent may be through text, voice, sign language, etc. For example, the user may be entering text at their PC whilst the BestBuy™ sales agent is accessed through a Skype conversation from ZINA to the BestBuy™ sales agent or through a telephone call. It would be evident that the ZINA ZiNation consumer side interface 9200 may acquire user queries through multiple formats.

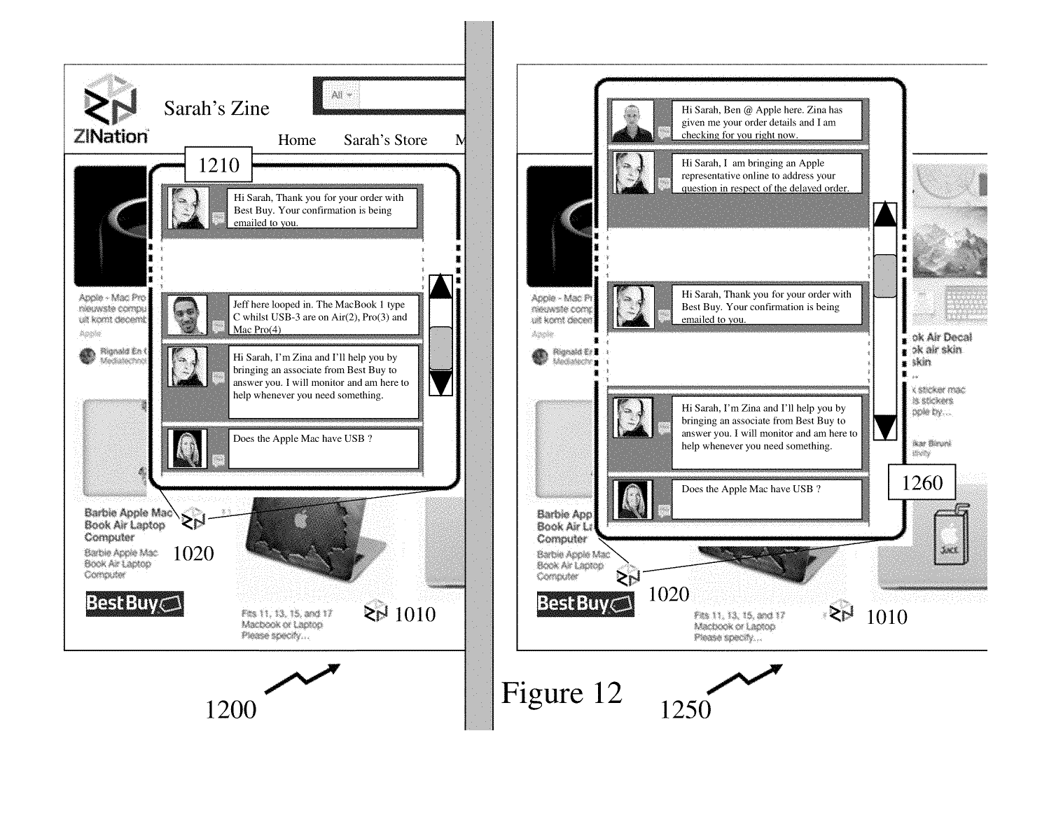

Now referring to FIG. 12 there are depicted first and second images 1200 and 1250 respectively with respect to a consumer' s ZINE (Co-ZINE) accessed through a web portal such as ZiNation directly or through an application plug-in for a social network etc. exploiting an E-CoCo system according to an embodiment of the invention. Within first image 1200 a first pop-up 1210 triggered through the users selection of the ZINA icon 1010, selected ZINA icon 1020, associated with “Barbie Apple Mac Book Air Laptop”. It would be evident that the ZINA icon 1010 may be displayed in a different format when a response has been received which the user has not viewed such as having the icon flashing, having a numeral displayed indicating the number of “unviewed” messages, etc. or the pop-up may be displayed with the latest message(s) highlighted, flashing, etc. Within first pop-up 1210 the final message indicates that the user “Sarah” has now placed an order. Within embodiments of the invention the ZiNation system acts a central ordering point or the user can right-click the image of the item, e.g. “Barbie Apple Mac Book Air Laptop”, and be linked to the retailer engaged within the conversation thread depicted within the first pop-up 1210. If the thread has not progressed such that a specific retailer/provider is engaged, then the selection of the option to buy may trigger ZINA to query “Do you want to contact BestBuy™ or would you prefer to use Amazon™ as usual?” for example. The response provided by the user then triggers the appropriate retailer engagement.

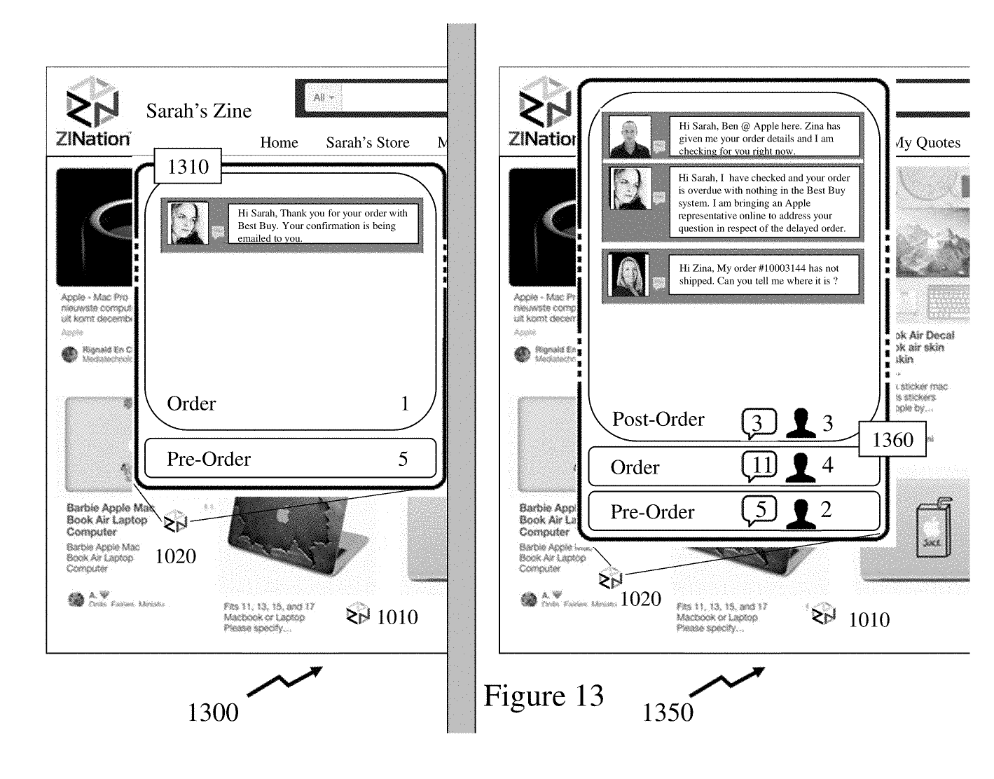

In contrast, referring to second image 1250 second pop-up 1260 reflects an extension of the conversation thread wherein “Sarah” has ordered the laptop computer and is now querying delivery. However, as her preferred buying option for Apple™ products was Apple™ itself her query in respect of the order now loops an Apple™ representative into the conversation. Within embodiments of the invention both “Sarah” and the Apple™ representative may see the full conversation thread or as discussed below in respect of FIG. 13 the retailer may see only part of the conversation initially unless the user approves opening the earlier stages of the conversation thread to the representative. This partitioning may be achieved with ease within some embodiments of the invention as the retailer may be accessing the overall system through ZANI whereas the user does so through ZINA and hence there is a partitioning managed by the system. This may be particularly beneficial where the conversation the user initially has within ZANI may be with friends or family, such as for example, an individual who recommended the product or whose input/thoughts/opinions the user values.

Now referring to FIG. 13 there are depicted first and second images 1300 and 1350 respectively with respect to a consumer's ZINE (Co-ZINE) accessed through a web portal such as ZiNation directly or through an application plug-in for a social network etc. exploiting an E-CoCo system according to an embodiment of the invention Within first image 1300 a first pop-up 1310 is displayed wherein the conversation has been partitioned by ZINA into “Pre-Order” and “Order.” This demarcation being relatively simple to define as the order generates and submits an order. In second image 1350 the second pop-up 1360 represents an alternate depiction whilst also displaying it at a subsequent point in time where the conversation is now split into “Pre-Order”, “Order”, and “Post-Order.” Each is also depicting the number of conversation elements and the number of individuals within the conversation, e.g. for “Order” it now indicates that there are 11 conversation items between 4 individuals. It would be evident that tools for navigating through the conversation such as scroll bars, up/down buttons etc. and others as known in the art may be employed.

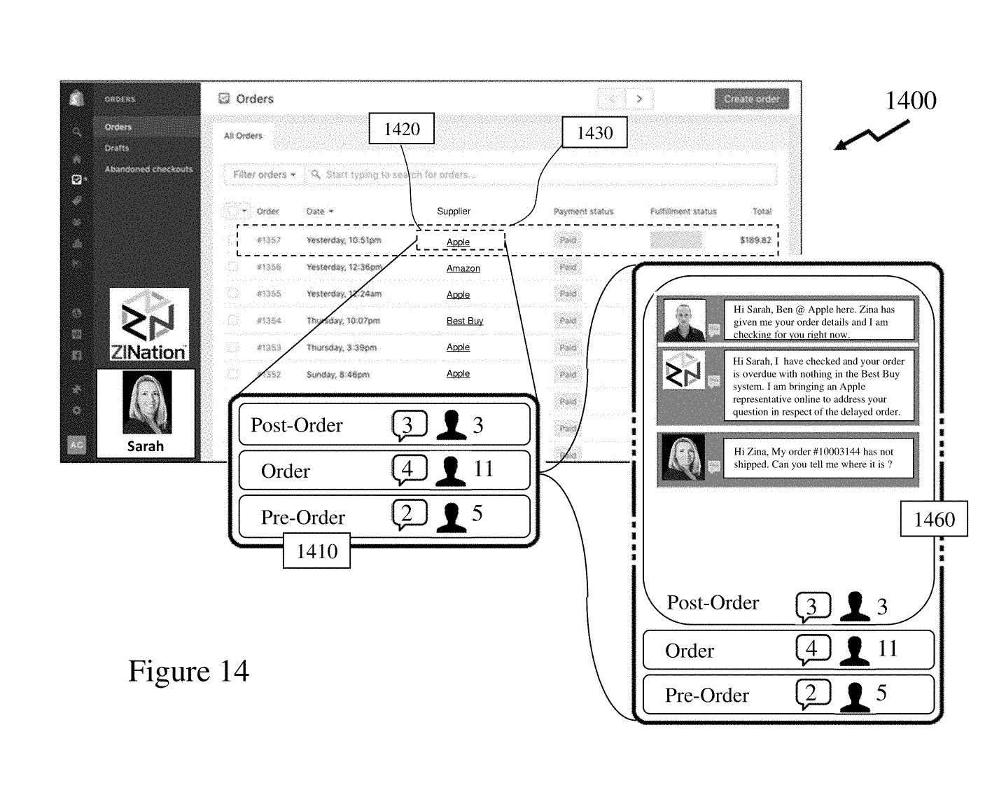

Now referring to FIG. 14 there is depicted a web screen 1400 for a user accessing their order history within an application exploiting ZINA (as customer facing conversational system) as an E-CoCo plug-in within an ECEAP such as Spotify™ exploiting an E-CoCo system according to an embodiment of the invention. Accordingly, the web screen 1400 depicts the orders made by “Sarah” of which a selected order 1430 is identified, in this instance to Apple™ If the user selects the supplier 1420 hyperlink then a first pop-up 1410 opens presenting the user with a conversation window which shows their conversation in several stages, in this instance Pre-Order, Order, and Post-Order. Selection of one of these, e.g. Post-Order, triggers the first pop-up to evolve into second pop-up 1460 wherein the Post-Order conversation is displayed to the user.

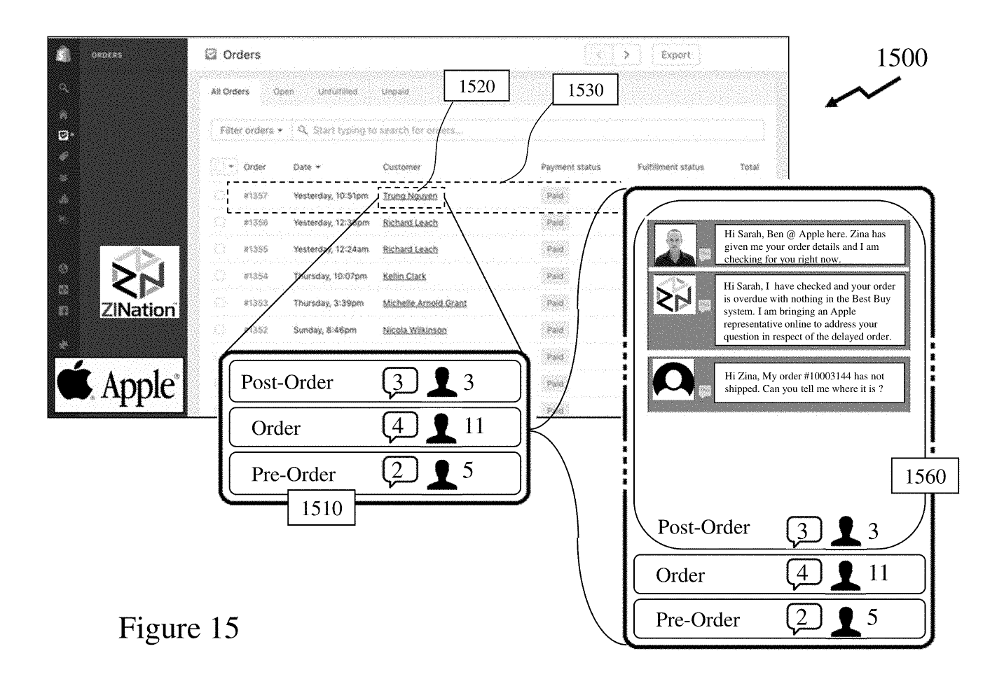

Referring to FIG. 15 there is depicted a web screen 1500 for a user within an enterprise, e.g. Apple™, accessing an order history within an application exploiting ZANI (as business facing conversational system) as an E-CoCo plug-in within an ECEAP such as Spotify™ exploiting an E-CoCo system according to an embodiment of the invention. Accordingly, the web screen 1500 depicts the orders made by consumers to the enterprise wherein a selected order 1430 is identified, in this instance by customer 1520, “Sam York.” Upon selecting the user 1420 hyperlink then a first pop-up 1410 opens presenting the user with a conversation window which shows the conversation with this customer for this order in several stages, in this instance Pre-Order, Order, and Post-Order. Selection of one of these, e.g. Post-Order, triggers the first pop-up to evolve into second pop-up 1560 wherein the Post-Order conversation is displayed to the user relating to the order. It would be evident that within second pop-up 1560 the identity of the consumer has been anonymised although if the consumer provides appropriate permissions then their image may be provided to the enterprise.

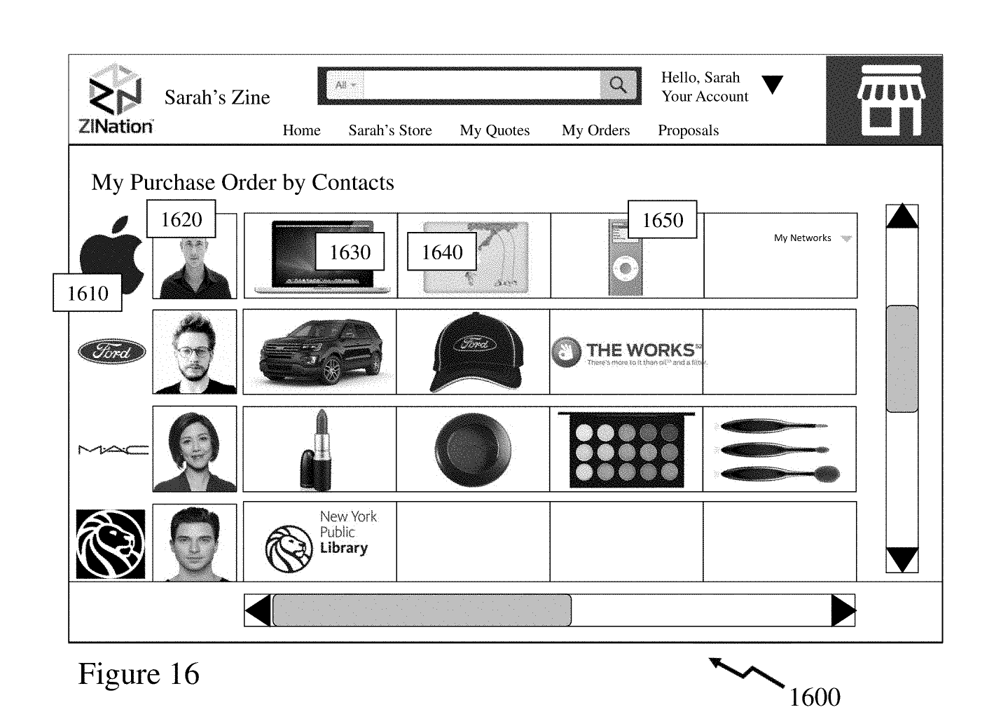

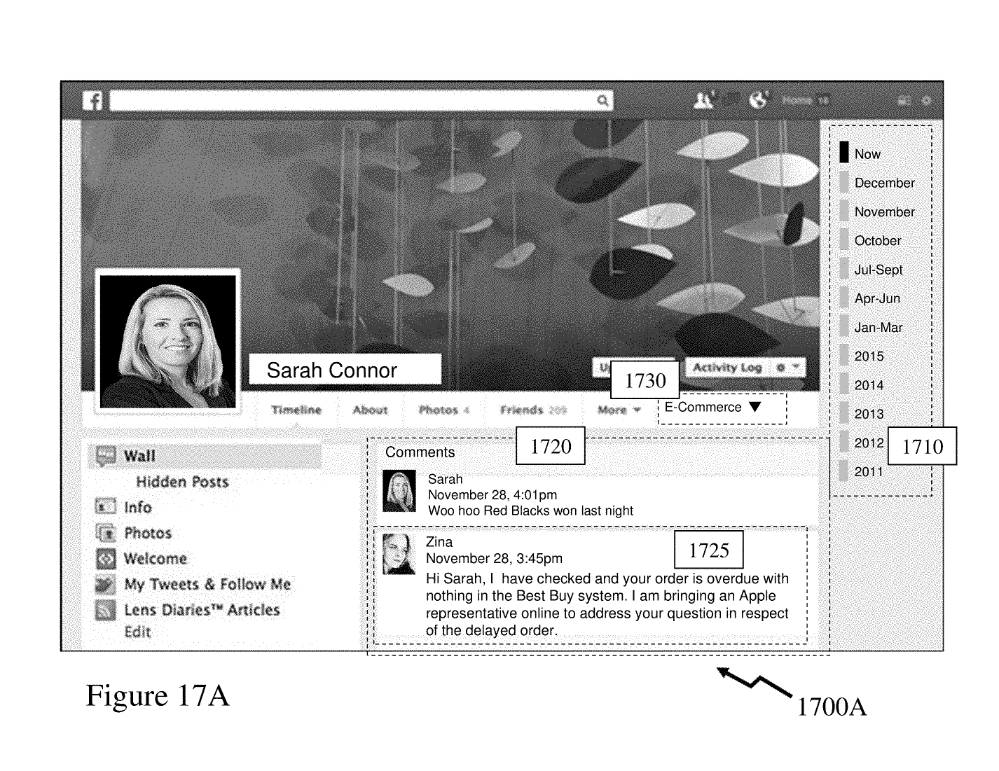

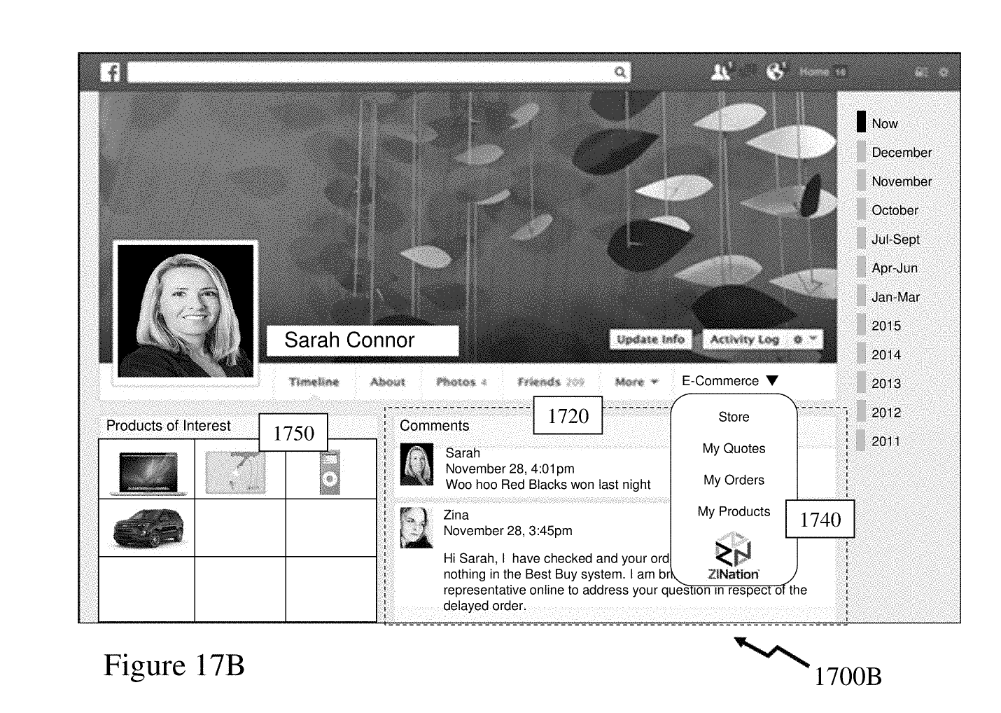

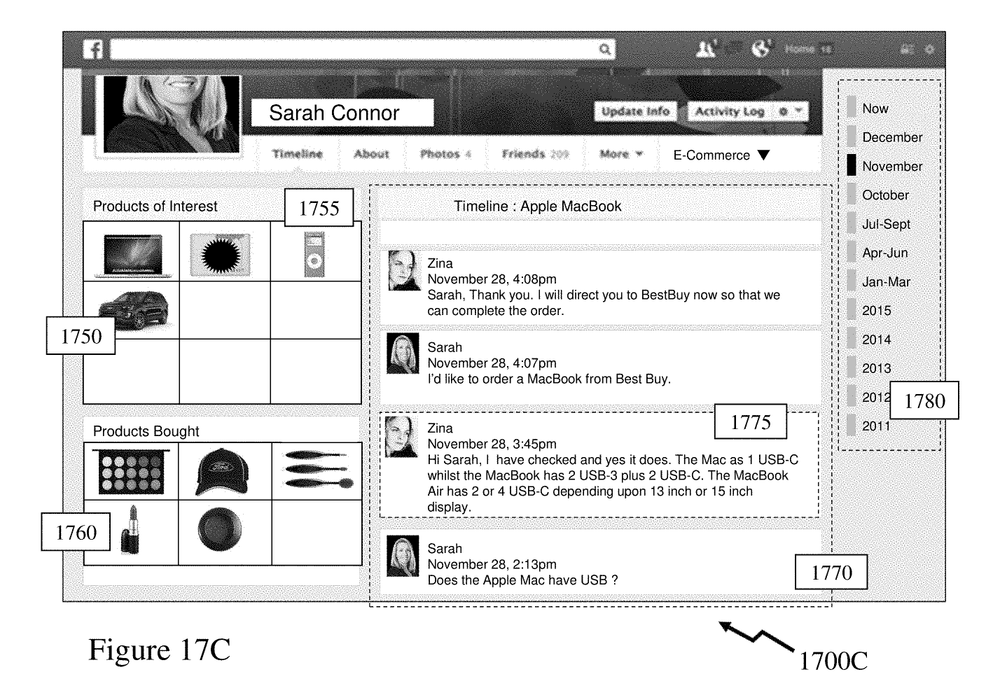

Now referring to FIG. 16 there is depicted an alternative user presented first web screen 1600 exploiting an E-CoCo system according to an embodiment of the invention. As depicted the purchases made by the user, “Sarah”, are presented but where these are depicted by the contact 1620 the user has conversed with wherein the contact's organization 1610 is also depicted to the left of the contact 1620. Accordingly, there are depicted across the web screen 1600 the user's purchases such as first to third purchases 1630 to 1650 respectively are presented by image rather than requiring the user to remember the specific description, retailer, etc. of the purchases they made. Accordingly, if the user selects an item, e.g. second purchase 1640, then they are presented with second web screen 1700 as depicted in FIG. 17 wherein pop-up 1710 is presented being a similar pop-up window as that described and depicted supra in respect of FIG. 14 and second pop-up 1460.

Referring to FIGS. 17A to 17C depict an e-commerce communication (E-CoCo) management system according to an embodiment of the invention within an application embedded as an add-on to a social network (SOCNET) wherein the e-commerce communication management system presents communications via the familiar user interface of the SOCNET for the user. Within FIG. 17A the e-commerce communication management system is accessible via “E-Commerce” button 1730 within the toolbar of the SOCNET in order to access all of its features. However, the conversational aspects of the E-CoCo are still active within the user's “Comments” section 1720 of their first SOCNET user interface (UI) 1700A as evident from the message in message field 1725 from Zina™ the consumer side facing interface of the E-CoCo. Also presented as part of the first SOCNET UI is a timeline 1710 allowing the user to rapidly scroll through and/or to-from specific time periods.

Now referring to FIG. 17B the user has selected the “E-Commerce” button 1730 of the E-CoCo application embedded as an add-on to the SOCNET. Accordingly, a second SOCNET UI 1700B presents a pop-up 1740 providing the user with a variety of e-commerce functions which in this illustration are, but are not limited to, “Store”, “My Quotes”, “My Orders”, and “My Proposals” together with the E-CoCo provider icon, in this instance ZiNation™. Further, the left-hand portion of the SOCNET UI previously displaying SOCNET related content such as links to the user “Wall”, Info, Photos etc. is replaced with “Products of Interest” 1750 which relate to products the user has started conversations for but has not at this point in time progressed to ordering. If the user now selects, for example, an item 1755 within the “Products of Interest” 1750 the “Comments” section 1720 is replaced with “Timeline” 1770 within which are conversation elements 1775 as depicted in FIG. 17C in third SOCNT UI 1700C. As the user selected item 1755 being an Apple MacBook then the “Timeline” 1770 reflect the conversation for this product and a modified timeline 1780 displays a marker to denote the period of time over which the conversation(s) were active. In this instance, the modified timeline 1780 denotes the conversations as being in November 2016 “Apple MacBook.” If the conversation(s) had spread over a longer period this would have been similarly identified within the modified timeline 1780 and the user would be able to scroll through the conversation through the SOCNET UI using a mouse, scroll-wheel etc. as known in the art discretely or in combination with “jumping” by selecting a depicted time frame within the modified timeline 1780. Also depicted within third SOCNET UI 1700C are “Products Purchased” 1760 indicating those items for which conversations exist and the status has moved to ordering.

It would be evident that rather than “Products of Interest” and “Products Bought” that products may be displayed in other filtered combinations such as “Interest”, “Ordered”, “Delivered” may be employed as well as “Recommended” and “Personal” etc. Optionally, the user may be able to define and select grouping criteria.

Accordingly, an E-CoCo application in combination with a SOCNET allows a user to enter active conversation and/or initiate new conversations through the “E-Commerce” button 1730 depicted in FIGS. 17A to 17C respectively in combination with the navigation/display aspects that the user is familiar within the SOCNET such as timeline. Whilst FIGS. 17A to 17C are focussed to the conversations relating to a “Product of Interest” similar conversations may be displayed for products and/or services in other categories set by default or based upon user defined filter criteria.

However, it would also be evident that whilst FIGS. 17A to 17C are focussed to the conversations relating to a “Product of Interest” the filtering applied, and the content displayed may vary according to whether the user selects “Store”, “My Quotes”, “My Orders”, or “My Proposals” in pop-up 1740 depicted in first SOCNET UI. For example:
“Store” may direct the user to a browser for searching a product or alternatively Zina™ may be directly engaged in a conversation relating to a product of interest wherein Zina™ having knowledge of the user purchasing history, search history etc. can engage the user to provide options from preferred vendors of the user or navigate the user through a structured search. In the instance that a browser based search is performed Zina™ may be engaged such that as the user visits different websites and/or product pages then a conversational thread of like/dislike/not sure etc. may ensue such that if the user wishes to return to that search Zina™ can intervene in the search results and filter them based on user responses or generate a Zine™ for presentation to the user based upon the previous search. Zina™ may accordingly be engaged from the very beginning and may act as a source of queries to help quantify the user's like/dislike etc.;
“My Quotes” may limit the display products and/or services and associated conversations to those the user has active relating to a product and/or service of interest but has not yet progressed to ordering;
“My Orders” may limit the display products and/or services and associated conversations to those the user has active relating to a product and/or service of interest ordered but has not yet progressed to delivery; and
“My Products” may limit the display products and/or services and associated conversations to those the user has active relating to a product and/or service of interest delivered.

Optionally, the pop-up menu 1740 may include other options such as “My Proposals” which relates to those products and/or services the user is quoting to other users and/or enterprises. Accordingly, the SOCNET UI methodology of embodiments of the invention may support a consumer, an enterprise, B2B, B2C, B2G, etc.

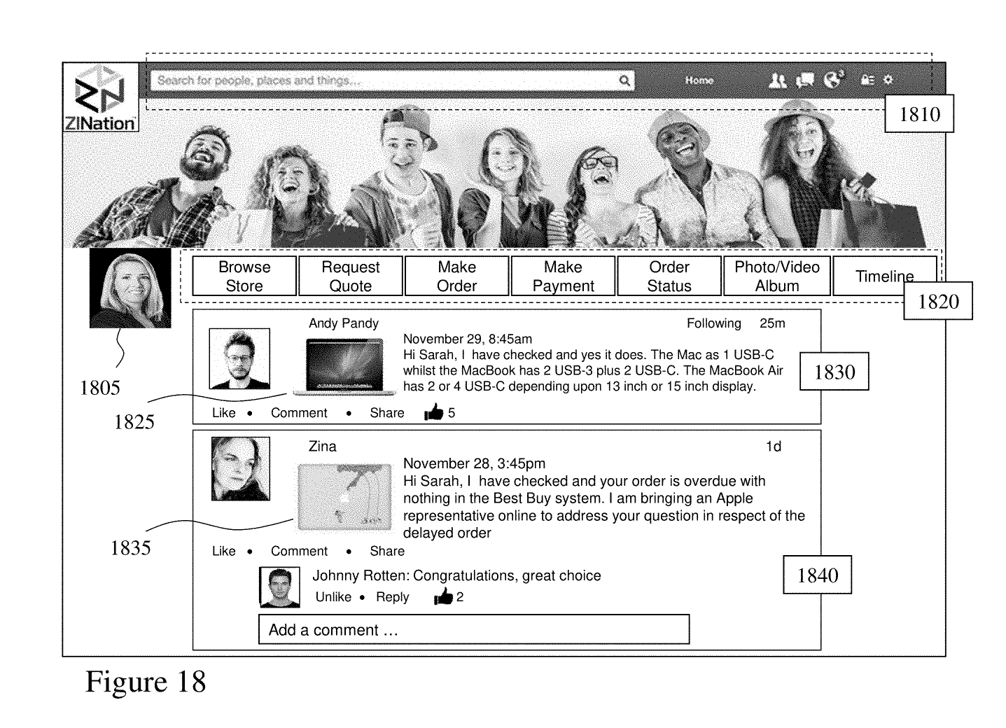

Now referring to FIG. 18 depicts an e-commerce communication (E-CoCo) management system according to an embodiment of the invention operating as a social network. Accordingly, as depicted a user 1805 has opened their personal profile within the E-CoCo social network wherein they are presented with an upper toolbar 1810 presenting them with options relating to the social network such as searching, returning to the “home” page, friend request indicator, messages indicator, and notifications indicator. Also depicted is activity toolbar 1820 which provides the user with e-commerce options including as depicted, but not limited to:
Browse Store: which provides for user searching such as described supra in respect of FIG. 17B which may be via a search engine, browser, or through the E-CoCo consumer side interface (Zina™);
Request Quote: wherein through the E-CoCo consumer side interface the user can request a quotation for a product or service they have selected through a search or identified via another means such as visiting a bricks-and-mortar retail establishment for example;
Make Order: wherein through the E-CoCo consumer side interface the user can trigger a purchase order;
Make Payment: wherein through the E-CoCo consumer side interface the user can make payment on an item they have ordered;
Order Status: wherein the user can query an active order through the E-CoCo consumer side interface;
Photo/Video Album: wherein the user can view items and/or advertisements that they have previously selected/tagged etc. but did not order;
Timeline: wherein the user can view a timeline of their communications across all activities or as filtered by time such as described supra in respect of FIG. 17C.

Also depicted are first and second conversations 1830 and 1840 respectively within the E-CoCo social network which are each anchored by a product and/or service such as first and second products 1825 and 1835 respectively. Accordingly, the user 1805 may enter a conversation through selection of a button within activity toolbar 1820 such as to start an order, check order status etc. Alternatively, where a conversation already exists they can access it through their active conversations, via the timeline or alternatively selection of a button within activity toolbar 1820 triggers the conversations, such as first and second conversations 1830 and 1840 respectively, to be filtered according to the selected criterion so that the user can access there.

Whilst the web browser interface depicted exploit text based entry of a conversation element it would be evident that the E-CoCo may support voice based conversations as well as those via other means such as voice-over-IP (VOIP), text etc. Optionally, plug-ins for the E-CoCo social network for other applications such as text (e.g. SMS, tweets, blogs etc.) and voice allows any activity within these applications to be mirrored into the E-CoCo social network such that the user may exploit the most convenient tool at a particular point, e.g. using SMS whilst within a retail establishment. Accordingly, the E-CoCo social network allows users to exploit familiar interfaces to perform e-commerce activities whether B2C, B2B, B2G, etc. Further, the E-CoCo social network provides a consistent interface across a wide range of enterprises providing products and/or services.

Within embodiments of the invention presented supra in respect of FIGS. 9 to 18 the conversation has been primarily presented from the viewpoint of a consumer interacting with a retailer and/or distributor and/or original equipment manufacturer.

Accordingly, it would be evident that the ZINA/ZANI E-CoCo system provides for central coordination of all conversations relating to a product and/or service allowing for uses including, but not limited to:
Between a user and their friends;
Between a user and a retailer;
Between a user and a distributor;
Between a user and an original equipment manufacturer;
Between a consumer, retailer, and the OEM.

Within the description and figures supra in respect of FIGS. 9A to 18 the user s engagements within the E-CoCo system according to embodiments of the invention are tracked/logged based upon a specific item or service such that multiple conversations with a single supplier/retailer are separated. Optionally, conversations may be grouped by different aspects such as product/service category, retailer, etc.

Within the description and figures supra in respect of FIGS. 9A to 18 the conversations within the E-CoCo system according to embodiments of the invention are accessed through a Zine™. However, it would be evident that within other embodiments of the invention the conversations may be tracked through one or more other applications executing E-CoCo plug-ins and/or accessing a remote E-CoCo application such as, for example, an electronic mail application, a social network application, a social network webpage, and a webpage.

Within the description and figures supra in respect of FIGS. 9A to 18 the conversations within the E-CoCo system according to embodiments of the invention are accessed through a Zine™. However, within other embodiments of the invention the E-CoCo system may be integrated directly or via a plug-in with one or more systems including, but not limited to, PIM system 820, PS system 830, AAI system 840, and OM system 860 as well as other systems including, but not limited to, cloud-based team collaboration tools such as Slack™, accounting software such as Quickbooks™, ERP systems, CRM systems, and call centre management software.

Within the description and figures supra in respect of FIGS. 9A to 18 the conversations within the E-CoCo system according to embodiments of the invention the E-CoCo system such as ZANI/ZINA may pull data from other software applications, databases etc. or it may push data to other software applications, databases etc. or form an enabling core to a software suite/ecosystem.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
tracking conversations relating to at least one of an item of merchandise and a service between multiple parties via an automated agent interacting with the multiple parties as at least one party of the multiple parties.

2. The method according to claim 1, wherein
each party of the multiple parties except the automated agent is selected from a group associated with the at least one of the item of merchandise and the service, the group comprising a consumer, a retailer, a distributer and an original equipment manufacturer.

3. The method according to claim 1, wherein
the automated agent acts as two or more parties of the multiple parties, one being customer centric downstream from the retailer and the other enterprise centric upstream from the retailer.

4. The method according to claim 1, wherein
tracking the conversations comprises acquiring them independent of the electronic medium of communication and associating them with the item of merchandise.

5. The method according to claim 1, wherein
the automated agent is associated with the at least one of the item of merchandise and the service displayed to the user within at least one of a website, a webpage and an electronic magazine; and
the automated agent and the tracked conversations are maintained in association with the is associated with at least one of the item of merchandise and the service within the at least one of the website, the webpage, and the electronic magazine for multiple stages of a sales cycle; wherein
the multiple stages comprise searching, ordering, delivery, and after sales service.

6. A method comprising:
hosting upon one or more servers a social network for a plurality of users wherein a first subset of the users are buyers of one or more at least one of products and services and a second subset of the users are sellers of the one or more at least one of products and services;
providing within the social network one or more automated agents for facilitating one or more communication sessions between a user of the first subset of the users and a user of the second subset of the users wherein the one or more communication sessions relate to at least of one of a purchasing decision, placing an order, checking on status of an order, order post-delivery, cancelling a service and returning a product; wherein
one user of the plurality of users is a consumer side orientated artificial intelligence driven persona of the social network for interacting with buyers; and
another user of the plurality of users is a supplier side orientated artificial intelligence driven persona of the social network for interacting with buyers

7. A method comprising:
providing a centralized communications portal supporting one or more conversation relating to an item between multiple parties via an automated agent interacting with the multiple parties as at least one party of the multiple parties; wherein
the item is at least one of a merchandise and a service.

8. The method according to claim 7, wherein
the automated agent interacts with two parties; wherein
the automated agent interacts with a first party of the two parties as a consumer side orientated artificial intelligence driven persona for interacting with buyers; and
the automated agent interacts with a second party of the two parties as a supplier side orientated artificial intelligence driven persona of the social network for interacting with buyers.

9. The method according to claim 7, wherein
the automated agent provides a user with a sequential thread of conversations relating to either an item of merchandise or a service wherein the thread of conversations involves the user and at least one of:
an individual associated with the user via a social network;
an enterprise associated with the item of at least one of the merchandise and the service; and
another automated agent.

10. The method according to claim 7, wherein
the automated agent is associated with the at least one of the item of merchandise and the service displayed to the user within at least one of a website, a webpage and an electronic magazine; and
the automated agent and the tracked conversations are maintained in association with the is associated with at least one of the item of merchandise and the service within the at least one of the website, the webpage, and the electronic magazine for multiple stages of a sales cycle; wherein
the multiple stages comprise searching, ordering, delivery, and after sales service.
